(19) United States
(12) Patent Application Publication
(10) Pub. No.: US 2012/0153710 A1
(43) Pub. Date: Jun. 21, 2012

(54) Wheel Assemblies

(75) Inventors: Paul Ryan, Wichita, KS (US); Robert A. Wood, Lincoln, NE (US)

(73) Assignee: DG Manufacturing, LLC

(21) Appl. No.: 13/329,097

(22) Filed: Dec. 16, 2011

Related U.S. Application Data
(60) Provisional application No. 61/424,478, filed on Dec. 17, 2010.
(60) Provisional application No. 61/424,053, filed on Dec. 16, 2010.

(51) Int. Cl. B60B 23/00

(52) U.S. Cl. 301/111.01

(57) ABSTRACT

An assembly for attaching a first and second wheel adjacent an object suitable for rolling movement, according to particular embodiments, comprises: (1) an axle defining a first end and a second end defining at least one recess, (2) a clip comprising a first clip portion defining an elongated channel, a second clip portion defining an opening, and a biasing mechanism that is adapted for biasing the first clip portion toward a first position. The first end of the axle is adapted for supporting the first wheel when the assembly is attached adjacent the object. The clip is adapted to facilitate maintaining the second wheel in a substantially fixed lateral position by positioning the second wheel adjacent the object and sliding the clip adjacent the axle's second end so that a portion of the clip defining the elongated channel engages the portion of the axle defining the recess.

### CROSS REFERENCE TO RELATED APPLICATIONS

This application claims the benefit of U.S. Provisional Application No. 61/424,478, entitled “Hand Trucks and Hand Truck Assembly Methods,” filed Dec. 17, 2010, and U.S. Provisional Application No. 61/424,053 filed on Dec. 16, 2010, entitled “Hand Trucks and Related Shipping Methods,” both of which are hereby incorporated herein by reference in their entirety.

### BACKGROUND

Wheel assemblies are often difficult and time consuming to assemble. Accordingly, there is a need for improved wheel assemblies that are relatively easy for a user to assemble.

### SUMMARY OF THE INVENTION

An assembly, according to various embodiments, is adapted for attaching a first wheel and a second wheel adjacent an object suitable for rolling movement when the object is at least partially supported by the first and second wheels. In particular embodiments, the assembly comprises: (1) an axle defining: (a) a first end that is adapted for supporting the first wheel when the assembly is attached adjacent the object; and (b) a second end that is adapted for supporting the second wheel when the assembly is attached adjacent the object; and (b) a clip that is adapted to facilitate maintaining the second wheel in a substantially fixed lateral position adjacent the object in which the second wheel is rotatably connected adjacent the object. In particular embodiments, the axle defines at least one axle recess adjacent its second end. In certain embodiments, the clip comprises: (1) a first clip portion defining an elongated channel, (2) a second clip portion defining an opening in the second portion, and (3) a biasing mechanism that is adapted for biasing the first clip portion toward a first position in which the opening is aligned with at least a portion of the elongated channel. In particular embodiments, the clip is adapted to allow a user to use the clip to facilitate maintaining the second wheel in the substantially fixed lateral position by executing one or more steps. In certain embodiments, the one or more steps include (1) positioning the second wheel adjacent the at least one axle recess; and (2) sliding the clip adjacent the second end so that: (a) a portion of the clip defining the elongated channel engages at least a portion of the axle defining the recess; and (b) at least a portion of the second end is disposed within the opening.

A method of attaching a first wheel and a second wheel adjacent an object suitable for rolling movement using an axle assembly comprises: (1) an axle defining a first end that is adapted for supporting the first wheel and a second end that defines at least one axle recess and is adapted for supporting the second wheel; and (2) a clip comprising a first clip portion defining an elongated channel, a second clip portion defining an opening in the second portion, and a biasing mechanism that is adapted for biasing the first clip portion toward a first position in which the opening is aligned with at least a portion of the elongated channel. In particular embodiments, the clip is adapted to facilitate maintaining the second wheel in a substantially fixed lateral position adjacent the object in which the second wheel is rotatably connected adjacent the object. In certain embodiments, the method comprises the steps of: (1) positioning the first wheel adjacent the first end such that the first end supports the first wheel adjacent the object; (2) positioning the second wheel adjacent the at least one axle recess; and (3) sliding the clip adjacent the second end so that: (a) a portion of the clip defining the elongated channel engages at least a portion of the axle defining recess; and (b) at least a portion of the second end is disposed within the opening.

### BRIEF DESCRIPTION OF THE DRAWINGS

Having described various embodiments in general terms, reference will now be made to the accompanying drawings, which are not necessarily drawn to scale, and wherein:

FIG. 1 is a front perspective view of a hand truck according to a first particular embodiment of the invention.

FIG. 2 is an exploded front perspective view of the hand truck of FIG. 1.

FIG. 3 is a side view of the body of the hand truck of FIG. 1.

FIG. 4 is a top view of the hand truck of FIG. 1.

FIG. 5 is a front perspective view of three hand truck bodies having the same structure as the hand truck body of FIG. 1. This figure shows the three hand truck bodies in a nested, mating configuration.

FIG. 6 is a side view of the three hand truck bodies of FIG. 5.

FIG. 7 is a front perspective view of a hand truck according to a further embodiment of the invention.

FIG. 8 is a front perspective exploded view of the hand truck body of FIG. 7.

FIG. 9 is a side view of the hand truck body shown in FIG. 8.

FIG. 10 is a top view of the hand truck shown in FIG. 7.

FIG. 11 is a front perspective view of three hand truck bodies having the same structure as the hand truck body of FIG. 8. This figure shows the three hand truck bodies in a nested, mating configuration.

FIG. 12 is a side view of the three hand truck bodies of FIG. 11.

FIG. 13 is a front perspective view of a hand truck according to a further embodiment of the invention.

FIG. 14 is a front perspective view of the hand truck of FIG. 13 with its wheels and axle removed.

FIG. 15 is a side view of the hand truck body of FIG. 13.

FIG. 16 is a top view of the hand truck body of FIG. 13.

FIG. 17 is a front perspective view of three hand truck bodies having the same structure as the hand truck body of FIG. 13. This figure shows the three hand truck bodies in a nested, mating configuration.

FIG. 18 is a top view of the three hand truck bodies of FIG. 17.

FIG. 19 is a side view of the three hand truck bodies of FIG. 17.

FIG. 20 is a front perspective view of a hand truck body according to yet another embodiment in a first orientation.

FIG. 21 is an exploded front perspective view of the hand truck of FIG. 20.

FIG. 22 is a front perspective view of the hand truck of FIG. 20 in a second orientation.

FIG. 23 is a front perspective view of three hand truck bodies having the same structure as the body of the hand truck shown in FIG. 20. This figure shows the three hand truck bodies in a nested, mating configuration.

FIG. 24 is a top view of the three hand truck bodies of FIG. 23.

FIG. 25 is a side view of the three hand truck bodies of FIG. 23.

FIG. 26 is a front perspective view of a hand truck according to a second particular embodiment of the invention.

FIG. 27 is a front perspective exploded view of the hand truck of FIG. 26.

FIG. 28 is a front perspective view of three hand truck bodies having the same structure as the body of the hand truck of FIG. 26. This figure shows the three hand truck bodies in a nested, mating configuration.

FIG. 29 is a front perspective view of a hand truck body according to yet another embodiment of the invention.

FIG. 30 is an exploded front perspective view of the hand truck body of FIG. 29.

FIG. 31 is a front perspective view of three hand truck bodies having the same structure as the body of the hand truck of FIG. 29. This figure shows the three hand truck bodies in a nested, mating configuration.

FIG. 32 is a front perspective view of a hand truck body according to a further embodiment of the invention.

FIG. 33 is a front perspective view of three hand truck bodies having the same structure as the hand truck body of FIG. 32. This figure shows the three hand truck bodies in a nested, mating configuration.

FIG. 34 is a perspective view of a shipping container containing the hand truck bodies of FIG. 1 in a nested, mating configuration.

FIG. 35 is a perspective view of a shipping container full of the hand truck bodies of FIG. 1 in a nested, mating configuration.

FIG. 36 is a perspective view of a shipping container full of the hand trucks of FIG. 1 in a fully assembled configuration.

FIG. 37 is a perspective exploded view of a hand truck according to a particular embodiment.

FIG. 38 is a detail view of an axle of the hand truck of FIG. 37.

FIG. 39 is a detail view of a first end of the axle of FIG. 38.

FIG. 40 is a detail view of a second end of the axle of FIG. 38.

FIG. 41 is a rear detail view of a clip of the hand truck of FIG. 37.

FIGS. 42-48 are perspective views of the progressive steps of assembling a wheel assembly of the hand truck of FIG. 37.

FIG. 49 is a front view of a hand truck bay.

FIG. 50 is a side view of the hand truck bay of FIG. 49.

### DETAILED DESCRIPTION OF VARIOUS EMBODIMENTS

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview of Various Hand Truck Designs

### First Exemplary Hand Truck

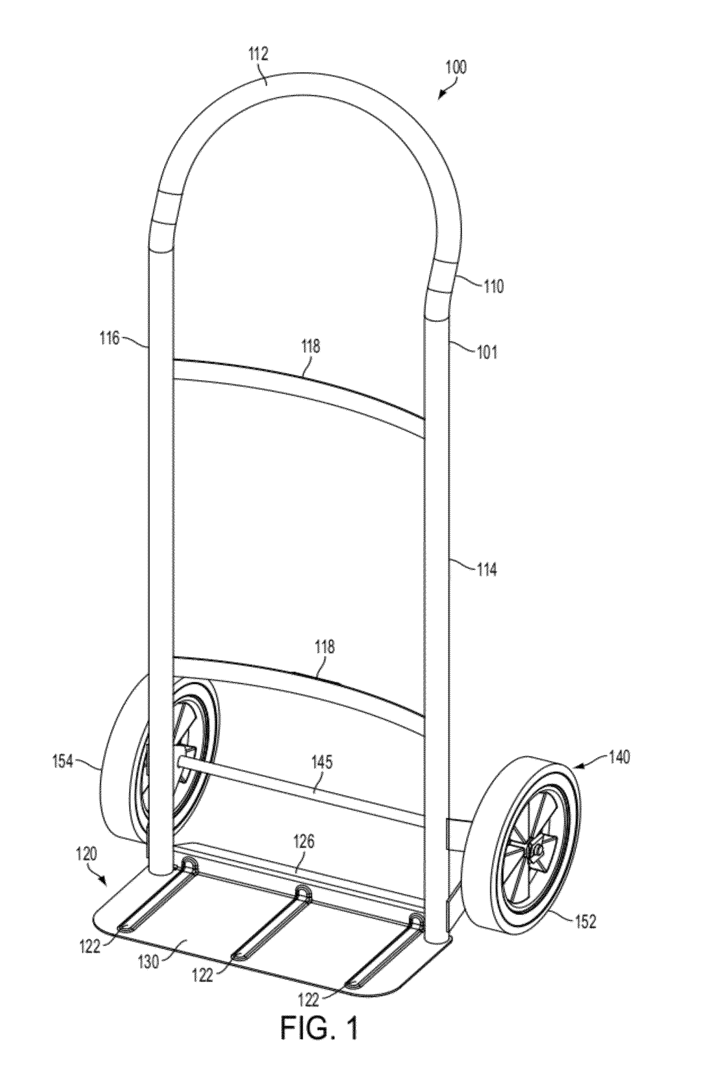

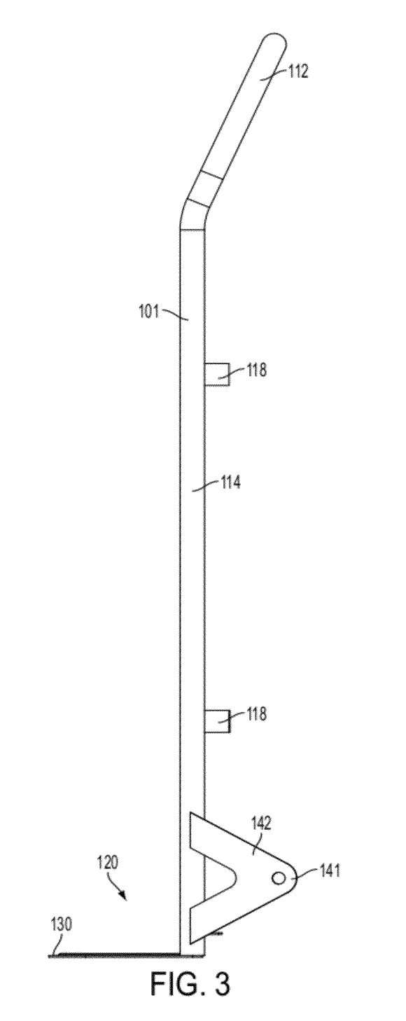

An exemplary hand truck according to a particular embodiment is shown in FIGS. 1-6. In this embodiment, the hand truck 100 comprises: (1) a frame 110; (2) a nose plate 120; and (3) a wheel assembly 140. These various components are discussed in greater detail below.

Frame

The hand truck 100 may include any suitable type of frame 110. In the embodiment shown in FIG. 1, this frame 110 includes: (1) a first side frame rail 114 (which, in this embodiment, is a substantially straight, elongated frame member that is adapted to stand in a substantially vertical orientation when the hand truck 100 is in an upright position); (2) a second side frame rail 116 (which, in this embodiment, is a substantially straight, elongated frame member that is adapted to stand in a substantially vertical orientation when the hand truck 100 is in an upright position); (3) a U-shaped connector 112 that connects the respective top ends of the first and second side frame rails 114, 116; and (4) a plurality of crossbars 118 that extend between, and physically connect, the first and second side frame rails 114, 116.

The various components of the frame 110 may be made of any suitable (preferably sturdy) material (e.g., a suitable metal such as aluminum or steel, or plastic). These components are secured together using any suitable combination of fasteners or welding techniques to provide a rigid frame for the hand truck 100.

Nose Plate

The hand truck 100 may include any suitable type of nose plate 120. As shown in FIG. 1, the nose plate 120 may include: (1) a substantially planar support plate 130 extending forward from the frame 110; and (2) a substantially planar face plate 126 that extends upwardly adjacent a rear edge of the support plate 130. In various embodiments, the support plate 130 may define one or more elongated ribs 122 in its top surface. As discussed in greater detail below, these ribs 122 correspond to elongated recesses in the support plate's bottom surface. In particular embodiments, the ribs 122 serve to provide additional strength to the support plate 130, and may also facilitate nesting the hand truck's body 101 (e.g., the structure of the hand truck 100 other than the hand truck's axle 145 and wheels 152, 154) with like hand truck bodies. The nose plate 120 may be attached to the lower end of the hand truck's frame 110 in any suitable manner (e.g., using suitable fasteners or welding techniques).

Wheel Assembly

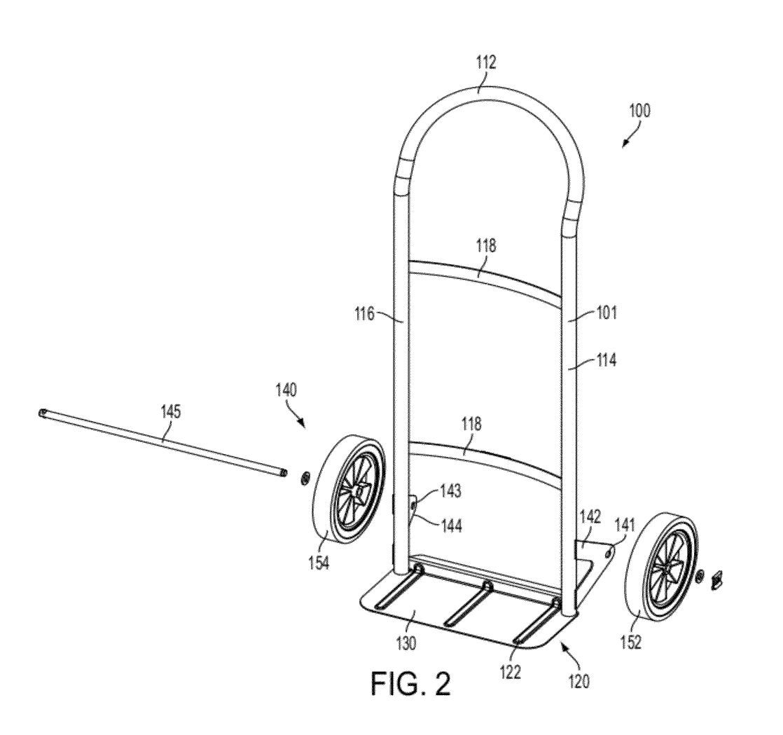

In particular embodiments, the hand truck's wheel assembly 140 is adapted for facilitating the movement of the hand truck 100 relative to a support surface. In the embodiment shown in FIG. 2, the wheel assembly 140 includes a first axle support 142 that extends outwardly and rearwardly adjacent the lower end of the first side frame rail 114 and a second axle support 144 that extends outwardly and rearwardly adjacent the lower end of the second side frame rail 116. The first and second axle supports 142, 144 each respectively define a substantially circular hole 141, 143 adjacent their distal end.

The hand truck 100 further includes an elongated axle 145 that extends through the holes 141, 143 in the first and second axle supports 142, 144 so that the axle 145 is substantially parallel to a support surface that supports the hand truck 100 when the hand truck 100 is in an upright orientation. The wheel assembly 140 further includes a pair of wheels 152, 154 that are rotatably mounted, respectively, to opposite ends of the axle 145.

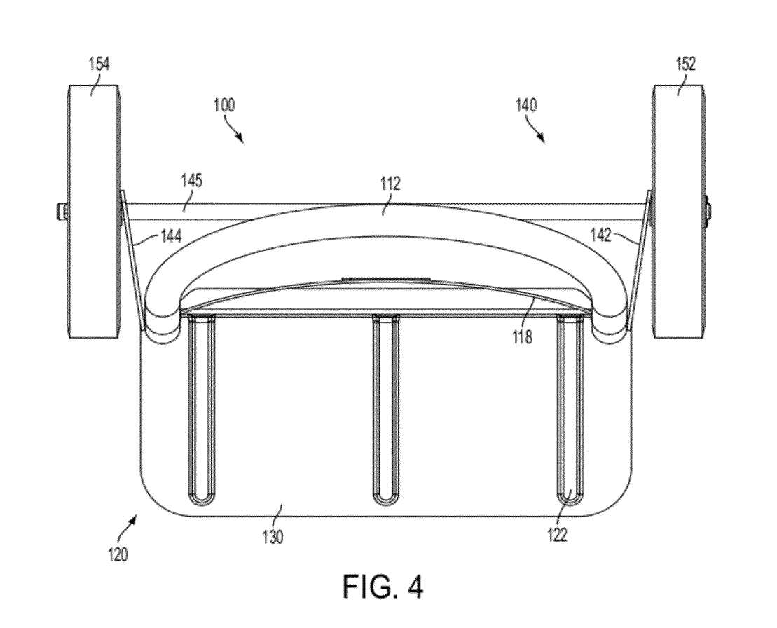

In particular embodiments, the first axle support 142 is in the shape of a substantially planar trapezoid with the first axle support's proximal end being the trapezoid's larger parallel side. Similarly, the second axle support 144 is in the shape of a substantially planar trapezoid with the second axle support's proximal end being the trapezoid's larger parallel side. As may be understood form FIG. 4, in particular embodiments, the first and second axle supports 142, 144 are flared away from each other so that the axle supports' respective proximal ends are closer to each other than the axle supports' respective distal ends.

Nesting Multiple First Exemplary Hand Truck Bodies

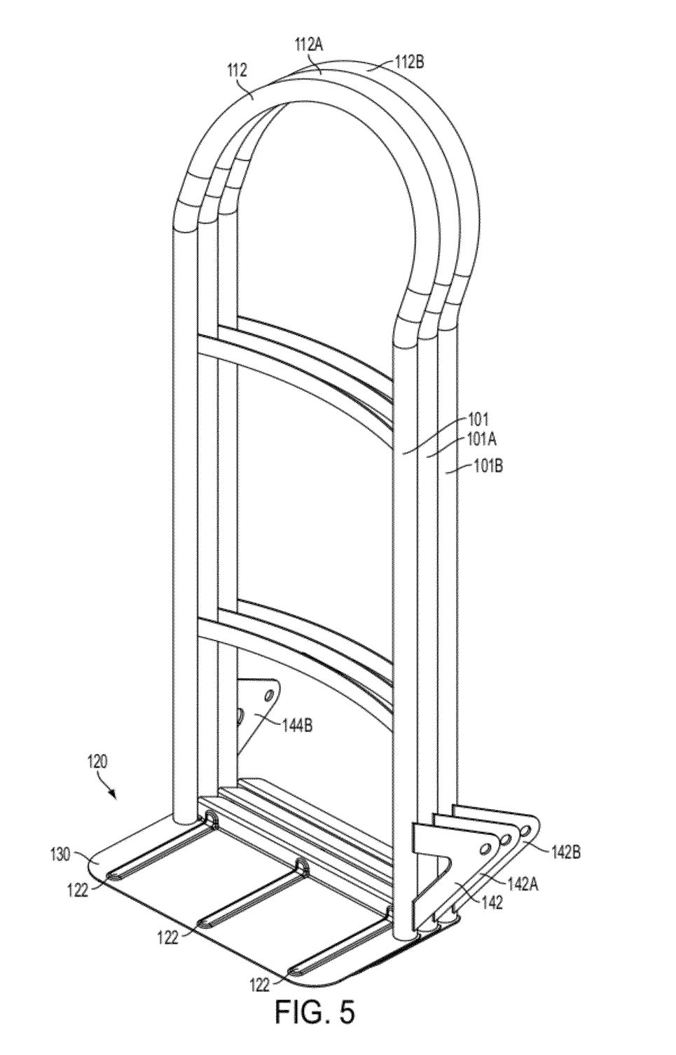

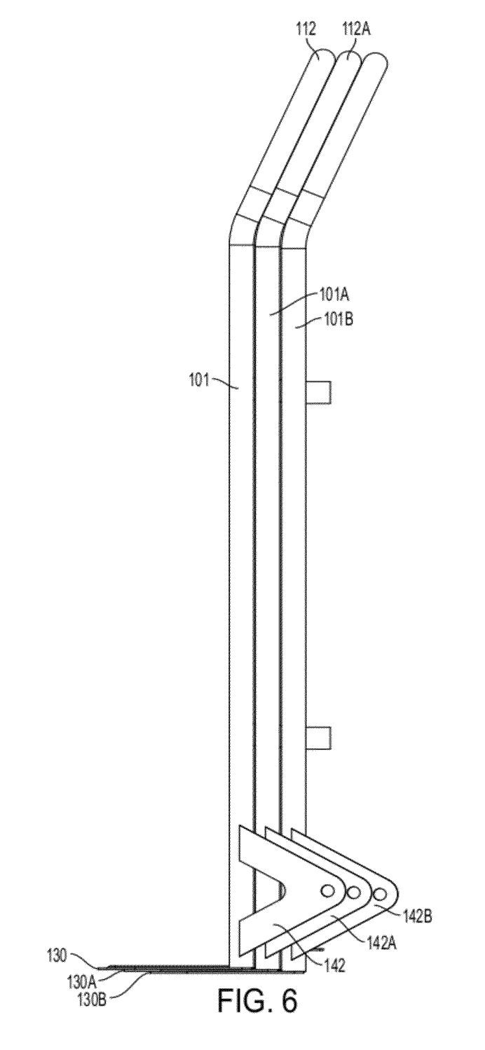

In various embodiments, the body 101 of the first exemplary hand truck 100 is adapted to nest with hand truck bodies having a structure that is the same as, or substantially similar to, the structure of the first exemplary hand truck body 101 (e.g., with “like” hand truck bodies). As may be understood from FIGS. 5 and 6, the first and second axle supports 142, 144 are adapted for facilitating moving two like hand truck bodies 101, 101A into a mating relationship. In particular, the flared positioning of the first 142 and second 144 axle supports serves to guide the first hand truck body 101 into the correct lateral mating orientation with the second hand truck body 101A as: (1) the respective inside surfaces of the first hand truck body's first 142 and second 144 axle supports engage the respective outside surfaces of the second hand truck body's first 142A and second (not pictured) axle supports; and (2) the first hand truck body 101 is moved toward the second hand truck body 101A.

FIGS. 5 and 6 show three like hand truck bodies 101, 101A-101B in a nested, mating relationship. The hand truck bodies 101, 101A-101B are dimensioned so that, when the hand truck bodies 101, 101A-101B are positioned in a nested, mating relationship as shown in FIG. 5: (1) the rear portion of the front hand truck body (e.g., hand truck body 101) engages, and at least substantially mates with (e.g., entirely mates with), the front portion of the rear hand truck body (e.g., hand truck body 101A); (2) as may be understood from FIG. 6, the inner surfaces of the first axle support 142 and second axle support (not pictured) of the front hand truck body 101 at least substantially mate with (e.g., entirely mate with), the outer surfaces of the first axle support 142A and second axle support 144 of the rear hand truck body (e.g., hand truck body 101A); (3) as shown in FIG. 6, the lower surface of the front hand truck body's support plate 130 engages, and at least substantially mates with (e.g., entirely mates with) the upper surface of the rear hand truck body's support plate 130A. For example, the various recesses defined in the lower surface of the front hand truck body's support plate 130 may substantially mate with respective ribs 122 defined in the upper surface of the rear hand truck body's support plate 130A; (4) as shown in FIG. 5, the rear surface of the U-shaped connector 112 of the front hand truck body 101 at least substantially mates with (e.g., entirely mates with) the front surface of the rear hand truck body's U-shaped connector 112A.

Although FIGS. 5 and 6 show the hand truck bodies 101, 101A-101B in a nested, mating relationship in which there is nothing between the various hand truck bodies 101, 101A-101B, it should be understood that the hand truck bodies 101, 101A-101B nest with like hand truck bodies with one or more objects positioned between the respective hand truck bodies. For example, in particular embodiments, marketing literature or a kit (e.g., a relatively thin kit) that includes one or more hand truck components (e.g., wheels and an axle for the hand truck) may be positioned between the hand truck bodies while the hand truck bodies are in a substantially nested relationship.

### Second Exemplary Hand Truck

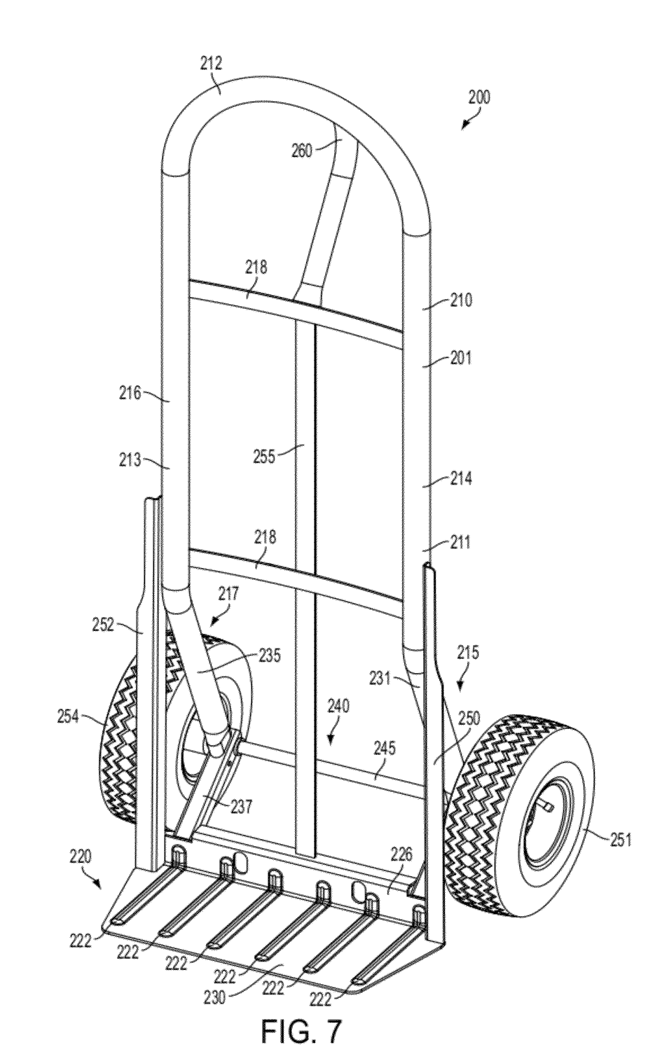

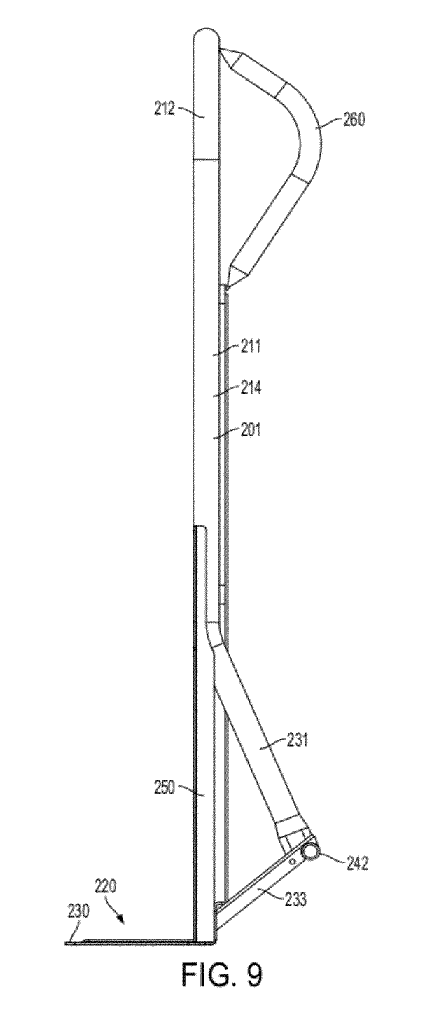

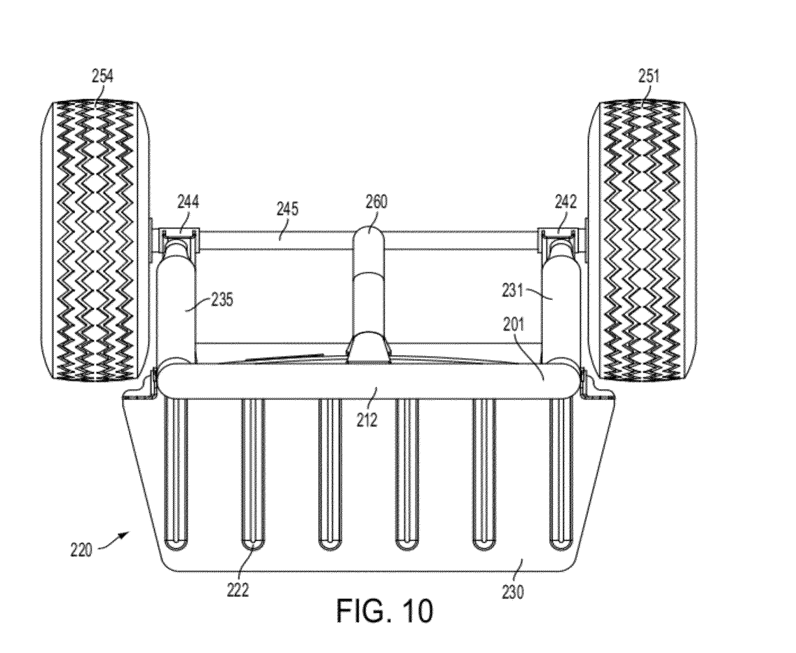

An exemplary hand truck according to a further embodiment is shown in FIGS. 7-12. In this embodiment, the hand truck 200 comprises: (1) a frame 210; (2) a nose plate 220; and (3) a wheel assembly 240. These various components are discussed in greater detail below.

Frame

The hand truck 200 may include any suitable type of frame 210. In the embodiment shown in FIG. 7, this frame 210 includes: (1) a first side frame rail 214; (2) a second side frame rail 216; (3) an upper connecting portion 212 that connects the respective top ends of the first and second side frame rails 214, 216; (4) a plurality of crossbars 218 that extend between, and physically connect, the first and second side frame rails 214, 216; (5) an elongated, substantially planar central support 255 that extends between the upper cross bar 218 and a rear middle edge of the nose plate 220; (6) a handle 260 that extends in a rearwardly directed arch between the upper portion of the central support 255 and the central portion of the upper connecting portion 212 as shown in FIG. 7; (7) a first elongated exterior support 250 that extends between the lower end of the upper portion 211 of the first side frame rail 214 and a first upper surface of the support plate 230; and (8) a second elongated exterior support 252 that extends between the lower end of the upper portion 213 of the second side frame rail 216 and a second upper surface of the support plate 230.

In the embodiment shown in FIG. 7, the first side frame rail 214 includes: (1) a substantially straight, elongated upper portion 211 that is adapted to stand in a substantially vertical orientation when the hand truck 200 is in an upright position; and (2) a first rearwardly extending angled axle support assembly 215 that extends between the lower end of the first side frame rail's elongated upper portion 211 and the first lateral side of the support plate 230.

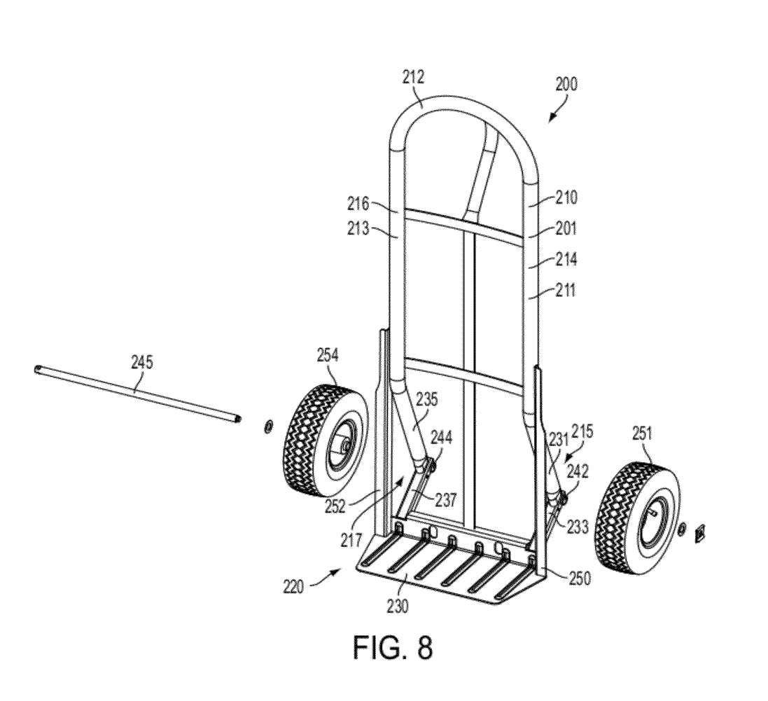

In the embodiment shown in FIG. 8, the first axle support assembly 215 comprises: (1) an elongated upper support member 231 that extends rearwardly and downwardly from the lower end of the first side frame rail's elongated upper portion 211; (2) an elongated lower support member 233 that extends rearwardly and upwardly from the first lateral side of the support plate 230; and (3) a first axle support 242 that is positioned at a vertex of an angle formed by the upper and lower support members 231, 233. In particular embodiments, the first axle support 242 is an elongated tube that is adapted for physically supporting a portion of an axle 245.

In particular embodiments of the disclosed technology, the upper support member 231 and lower support member 233 form an angle of between about 50 and about 90 degrees. Also, in various embodiments, such as the embodiment shown in FIG. 8, the upper and lower support members 231, 233 are positioned in a plane that is at least substantially perpendicular to (e.g., perpendicular to) the plane that includes the respective upper portions of the hand truck's first and second side frame rails 211, 213.

As shown in FIG. 7, the first exterior support 250 extends at least substantially vertically (e.g., vertically) when the hand truck 200 is in an upright orientation. In particular embodiments, the first exterior support 250 is positioned immediately adjacent the exterior lateral side of the first axle support assembly 215. Similarly, the second exterior support 252 extends at least substantially vertically (e.g., vertically) when the hand truck 200 is in an upright orientation. In particular embodiments, the second exterior support 252 is positioned immediately adjacent the exterior lateral side of the second axle support assembly 217.

In particular embodiments, the second side frame rail 216 includes: (1) a substantially straight, elongated upper portion 213 that is adapted to stand in a substantially vertical orientation when the hand truck 200 is in an upright position; and (2) a second rearwardly extending angled axle support assembly 217 that extends between the lower end of the second side frame rail's elongated upper portion 213 and the second lateral side of the support plate 230.

In the embodiment shown in FIGS. 7 and 8 the second axle support assembly 217 comprises: (1) an elongated upper support member 235 that extends rearwardly and downwardly from the lower end of the second side frame rail's elongated upper portion 213; (2) an elongated lower support member 237 that extends rearwardly and upwardly from the second lateral side of the support plate 230; and (3) a second axle support 244 that is positioned at a vertex of an angle formed by the second upper and lower support members 235, 237. In particular embodiments, the second axle support 244 is an elongated tube that is adapted for physically supporting a portion of the axle 245.

In particular embodiments of the disclosed technology, the upper support member 235 and lower support member 237 form an angle of between about 50 and about 90 degrees. Also, in various embodiments, such as the embodiment shown in FIG. 8, the upper and lower support members 235, 237 are positioned in a plane that is at least substantially perpendicular to (e.g., perpendicular to) the plane that includes the respective upper portions of the first and second side frame rails 214, 216.

The various components of the frame 210 may be made of any suitable (preferably sturdy) material (e.g., a suitable metal such as steel or aluminum, or plastic). These components are secured together using any suitable combination of fasteners or welding techniques to provide a rigid frame for the hand truck 200.

Nose Plate

The hand truck 200 may include any suitable type of nose plate 220. As shown in FIG. 7, the nose plate 220 may include: (1) a substantially planar support plate 230 extending forward from the frame 210; and (2) a substantially planar face plate 226 that extends upwardly adjacent a rear edge of the support plate 230. In various embodiments, the support plate 230 may define one or more elongated ribs 222 in its top surface. As discussed in greater detail below, these ribs 222 correspond to elongated recesses in the support plate's bottom surface. In particular embodiments, the ribs 222 serve to provide additional strength to the support plate 230, and may also facilitate nesting the hand truck body 201 with similar hand truck bodies. The nose plate 220 may be attached to the lower end of the frame 210 in any suitable manner (e.g., using suitable fasteners or welding techniques).

Wheel Assembly

In particular embodiments, the wheel assembly 240 is adapted for facilitating the movement of the hand truck 200 relative to a support surface. In the embodiment shown in FIG. 8, the wheel assembly 240 includes: (1) the first rearwardly extending angled axle support assembly 215; (2) the second rearwardly extending angled axle support assembly 217; (3) an elongated hand truck axle 245 that extends through the first and second axle supports 242, 244 so that the axle 245 is substantially parallel to a support surface that supports the hand truck 200 when the hand truck 200 is in an upright orientation; and (4) a pair of wheels 251, 254 that are rotatably mounted, respectively, to opposite ends of the axle 245.

Nesting Multiple Second Exemplary Hand Truck Bodies

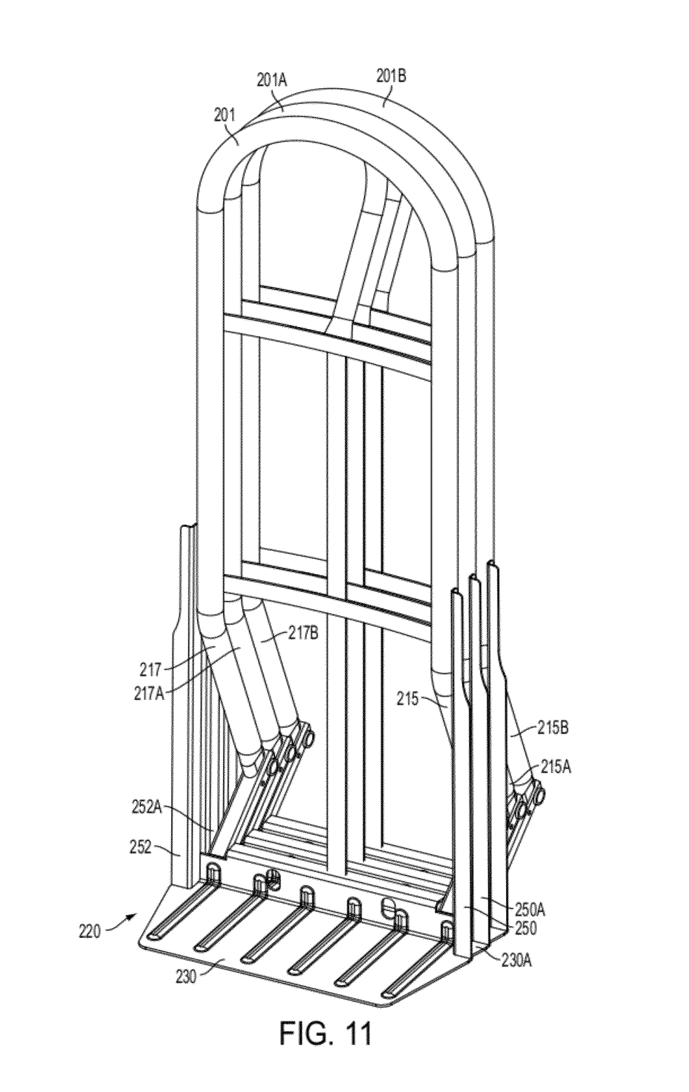

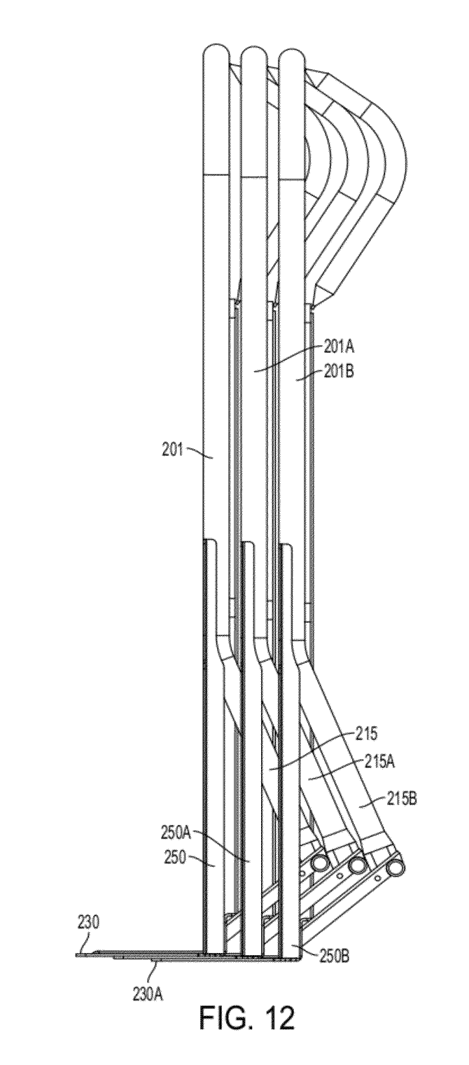

In various embodiments, the body 201 of the second exemplary hand truck 200 is adapted to nest with hand truck bodies having a structure that is the same as, or substantially similar to, the structure of the second exemplary hand truck body 201 (e.g., with “like” hand truck bodies). As may be understood from FIGS. 11 and 12, the first and second angled axle support assemblies 215, 217 and first and second exterior supports 250, 252 are adapted for facilitating moving two like hand truck bodies 201, 201A into a nested, mating relationship. In particular, as may be understood from 11 and 12: (1) the angled, rearwardly extending first and second angled axle support assemblies 215A, 217A of a hand truck body 201A each respectively form a recess for receiving the corresponding first or second angled axle support assembly 215, 217 of a like hand truck body 201; (2) the first exterior support 250A is adapted to engage the exterior surface of the like hand truck body's first angled axle support assembly 215; and (3) the second exterior support 252A is adapted to engage the exterior surface of the like hand truck body's second angled axle support assembly 217. This serves to: (1) facilitate guiding the two like hand truck bodies into a nested, mating relationship (e.g., as shown in 11); and (2) maintain the nested, like hand truck bodies in a nested, mating relationship (e.g., while the hand truck bodies are being transported).

FIGS. 11 and 12 show three like hand truck bodies 201, 201A-201B in a nested, mating relationship. As shown in this figure, in this embodiment, the hand truck bodies 201, 201A-201B are dimensioned so that, when the hand truck bodies 201, 201A-201B are positioned in a nested, mating relationship: (1) the rear portion of the body of the front hand truck (e.g., hand truck body 201) engages, and at least substantially mates with (e.g., entirely mates with), the front portion of the body of the rear hand truck body (e.g., hand truck body 201A); (2) the outer surfaces of the first and second angled axle support assemblies 215, 217 of the front hand truck body (e.g., hand truck body 201) at least substantially mate with (e.g., entirely mate with), the inner surfaces of the first and second angled axle support assemblies 215A, 217A of the rear hand truck body (e.g., hand truck body 201A); (3) the lower surface of the front hand truck body's support plate 230 engages, and at least substantially mates with (e.g., entirely mates with), the upper surface of the rear hand truck body's support plate 230A. For example, the various recesses in the lower surface of the front hand truck body's support plate 230 may substantially mate with respective ribs defined in the upper surface of the rear hand truck body's support plate 230A. As a result, the nesting of the like hand truck bodies and the like axle support assemblies may restrict the lateral movement of the hand trucks.

### Third Exemplary Hand Truck

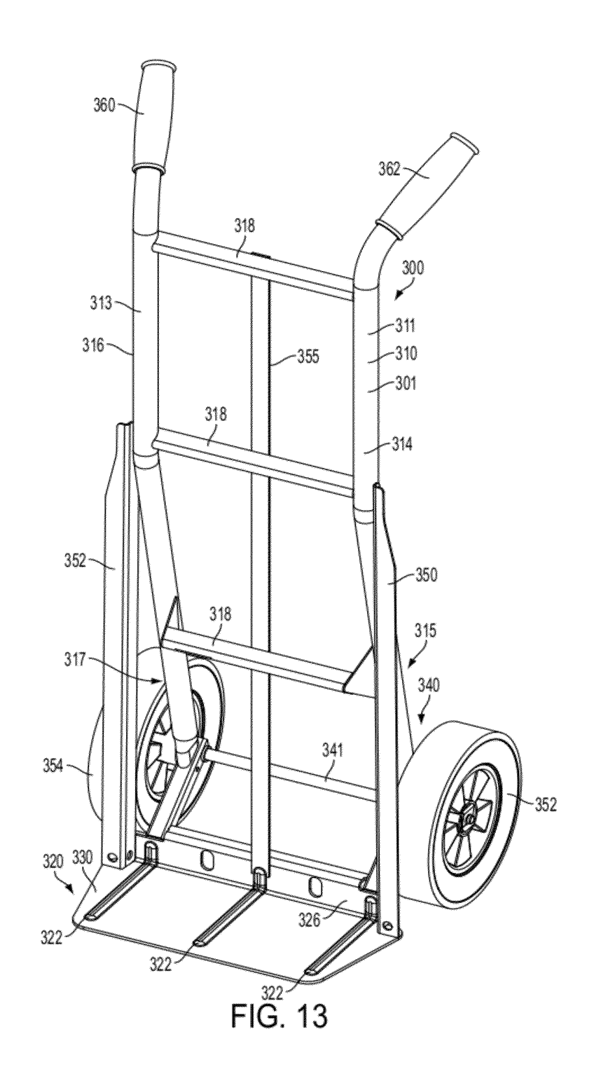

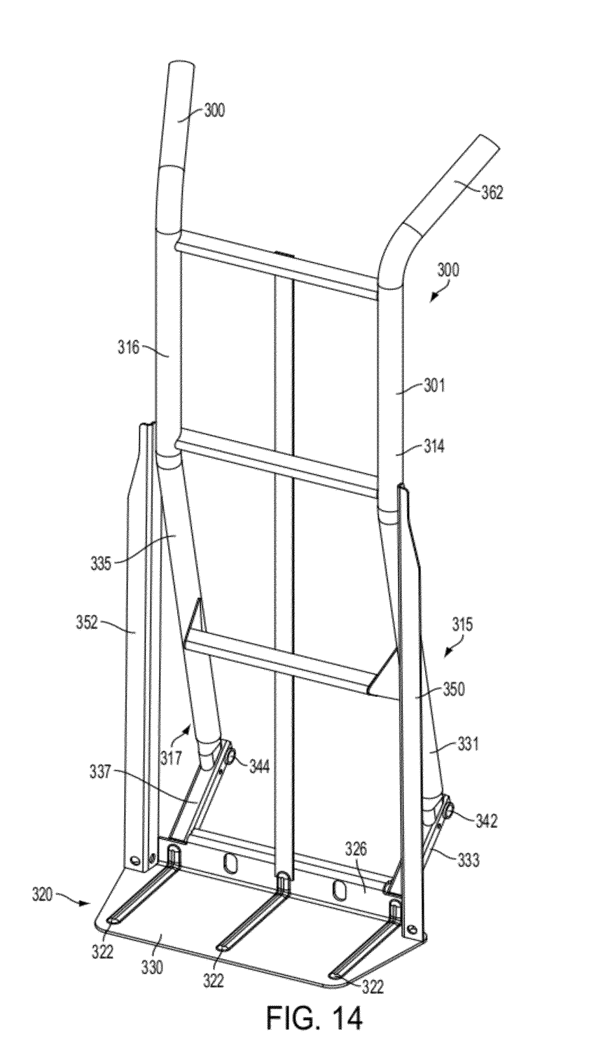

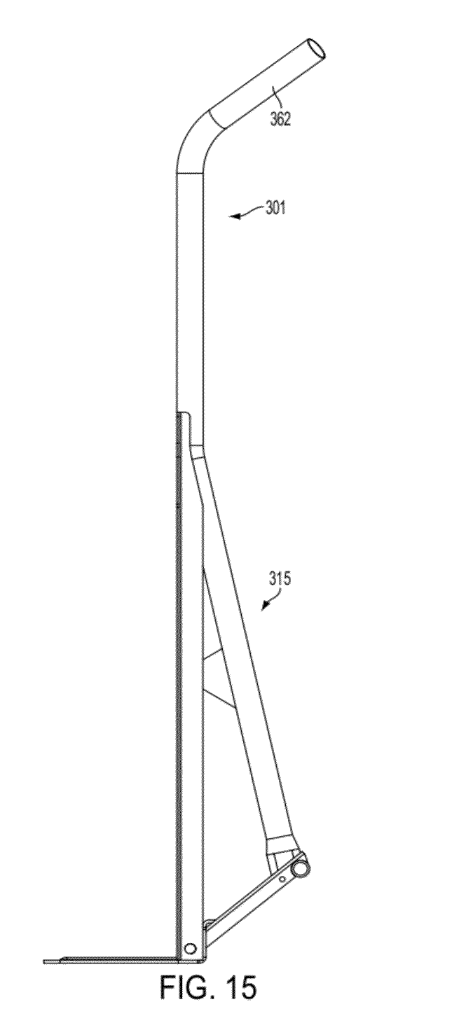

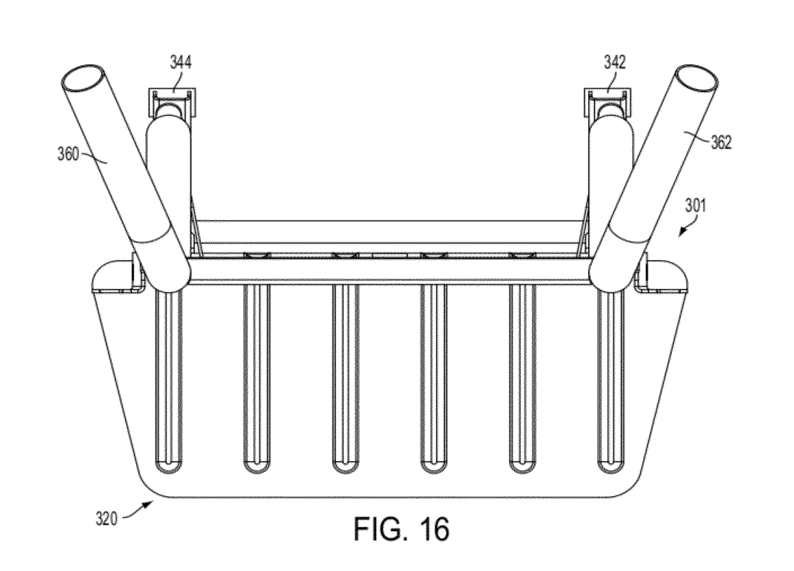

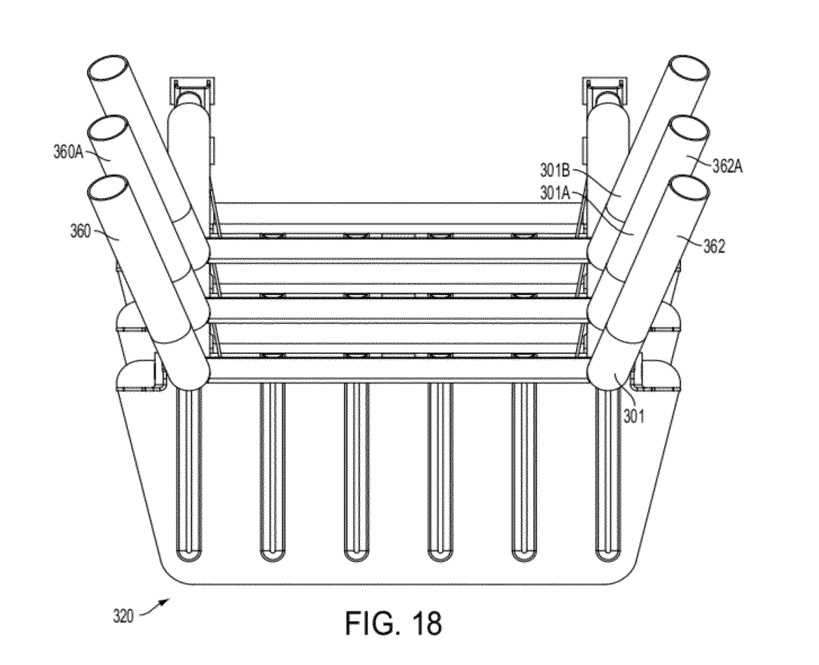

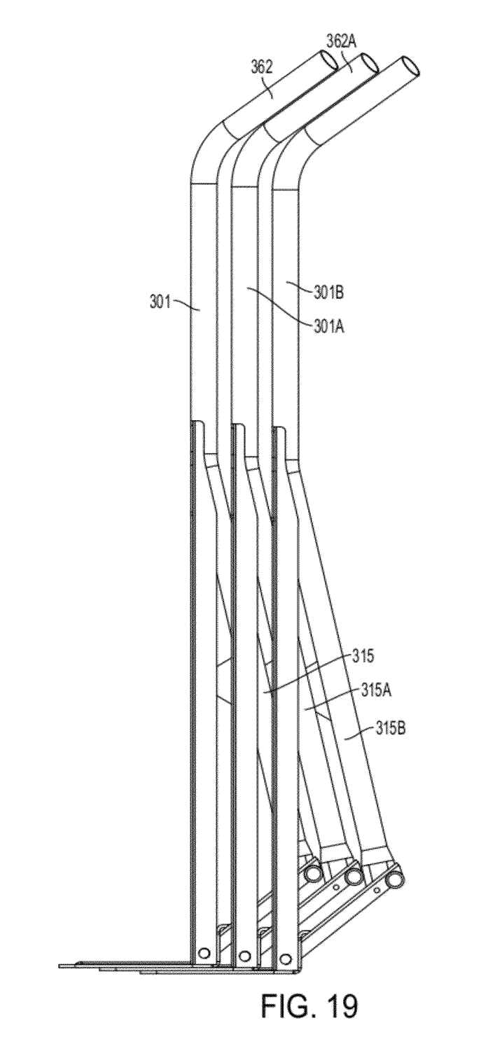

An exemplary hand truck according to a further embodiment is shown in FIGS. 13-19. In this embodiment, the hand truck 300 comprises: (1) a frame 310; (2) a nose plate 320; and (3) a wheel assembly 340. These various components are discussed in greater detail below.

Frame

The hand truck 300 may include any suitable type of frame 310. In the embodiment shown in FIG. 13, the frame 310 is substantially structurally similar (e.g., identical) to the frame 210 of the embodiment of the hand truck 200 shown in FIG. 7 without the handle 260 or upper connecting portion 212. In the embodiment of a hand truck 300 shown in FIG. 13, the frame 310 further comprises a first handle 362 that extends upwardly from an upper end of the first side frame rail 314 and a second handle 360 that extends upwardly from an upper end of the second side frame rail 316.

Nose Plate

In the embodiment shown in FIG. 13, the hand truck 300 includes a nose plate 320 that is substantially structurally similar (e.g., identical) to the nose plate 220 of the embodiment of a hand truck 200 shown in FIG. 7.

Wheel Assembly

In the embodiment shown in FIG. 13, the hand truck 300 also includes a wheel assembly 340 that is substantially structurally similar (e.g., identical) to the wheel assembly 240 of the embodiment of a hand truck 200 shown in FIG. 7.

Nesting Multiple Third Exemplary Hand Truck Bodies

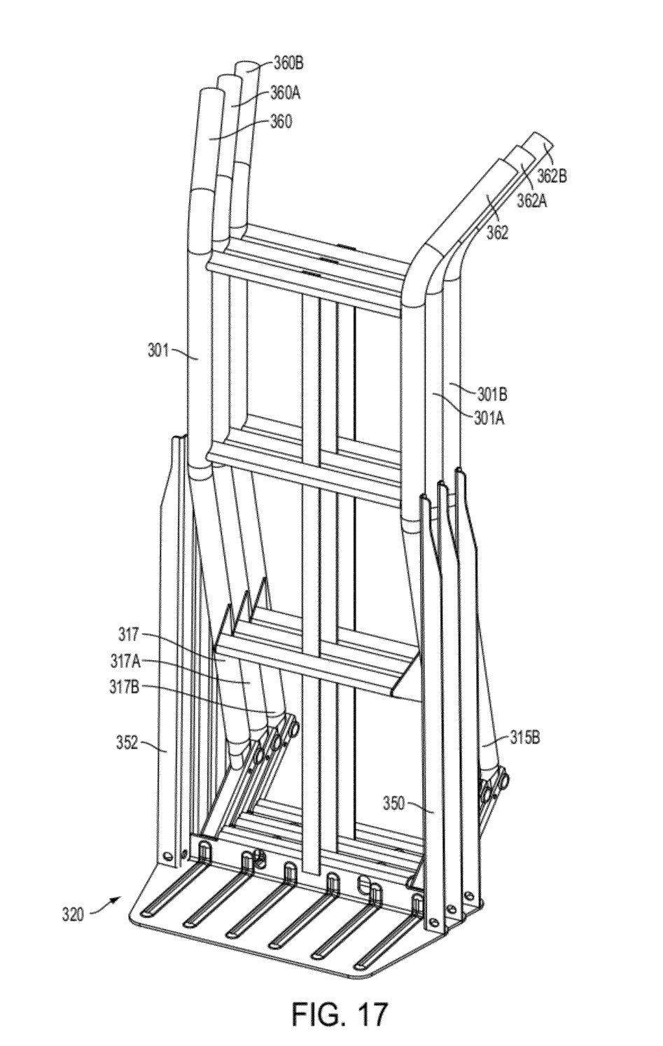

In various embodiments, the body 301 of the third exemplary hand truck 300 is adapted to nest with hand truck bodies having a structure that is the same or substantially similar to the structure of the third exemplary hand truck body 301 (e.g., with “like” hand truck bodies). As may be understood from FIG. 17, the hand truck body 301 is adapted to nest with like hand truck bodies in substantially the same manner as the hand truck body 201 of FIG. 7 is adapted to nest with like hand truck bodies

FIG. 17 shows three like hand truck bodies 301, 301A-301B in a nested, mating relationship. As may be understood from FIGS. 17-19, in this embodiment, the hand truck bodies 301, 301A-301B are dimensioned so that, when the hand truck bodies 301, 301A-301B are positioned in a nested, mating relationship, the rear portion of the first 362 and second 360 handles of the front hand truck body 301 at least substantially mate with (e.g., entirely mate with) the front of the first 362A and second 360A handles of the rear hand truck body 301A.

### Fourth Exemplary Hand Truck

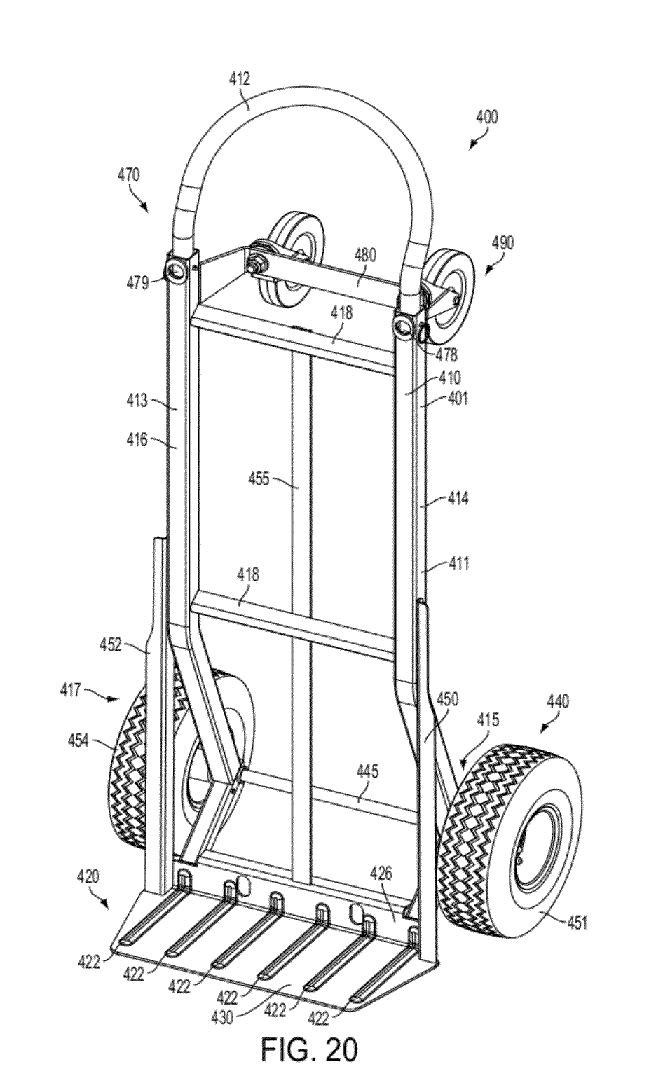

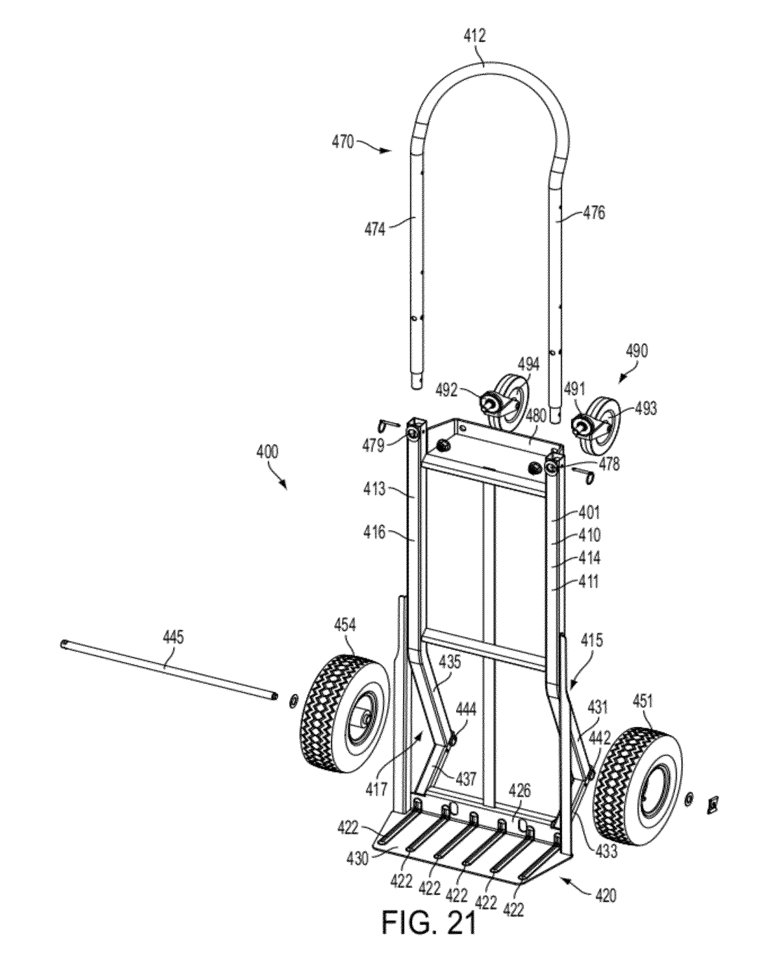

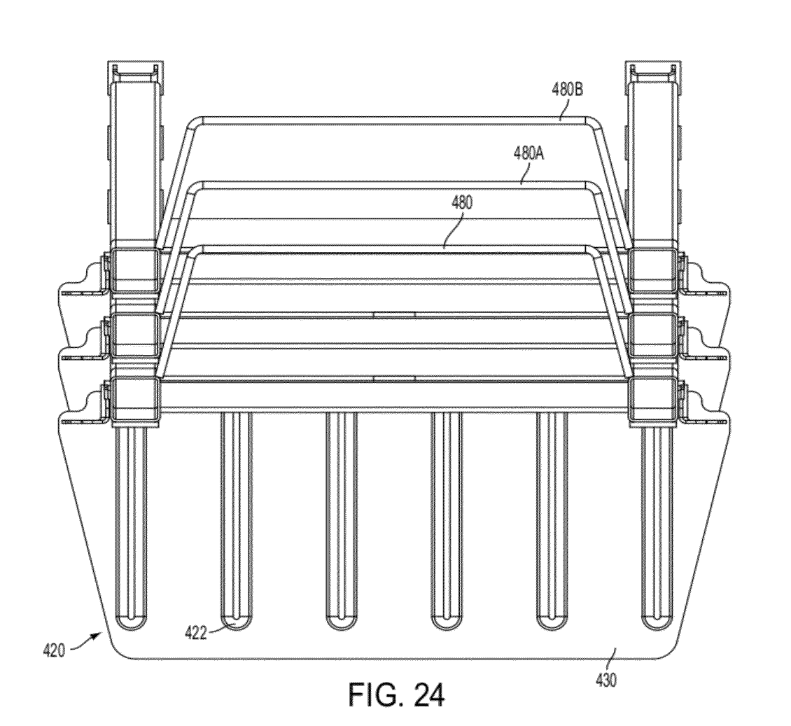

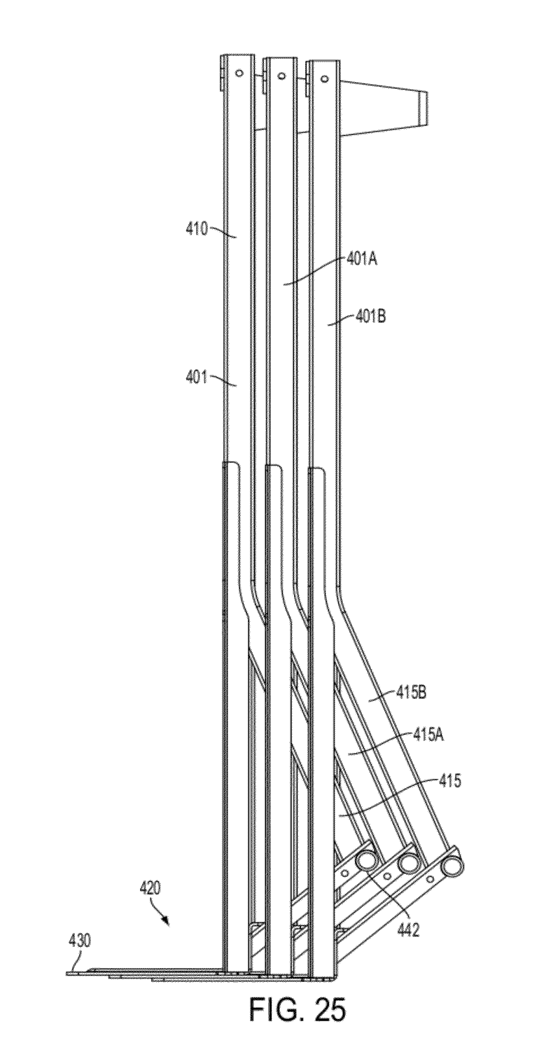

A fourth exemplary hand truck 400 is shown in FIGS. 20-25. As may be understood from these figures, the body of this hand truck 400 is, generally speaking, a convertible version of the hand truck body 200 shown in FIG. 7. In this embodiment, the hand truck 400 comprises: (1) a frame 410; (2) an upper handle assembly 470; (3) a nose plate 420; (4) a primary wheel assembly 440 (which is shown in FIG. 21 with the wheel assembly's axle 445 and wheels 451, 454 removed for purposes of clarity); and (5) a secondary wheel assembly 490. These various components are discussed in greater detail below.

Frame

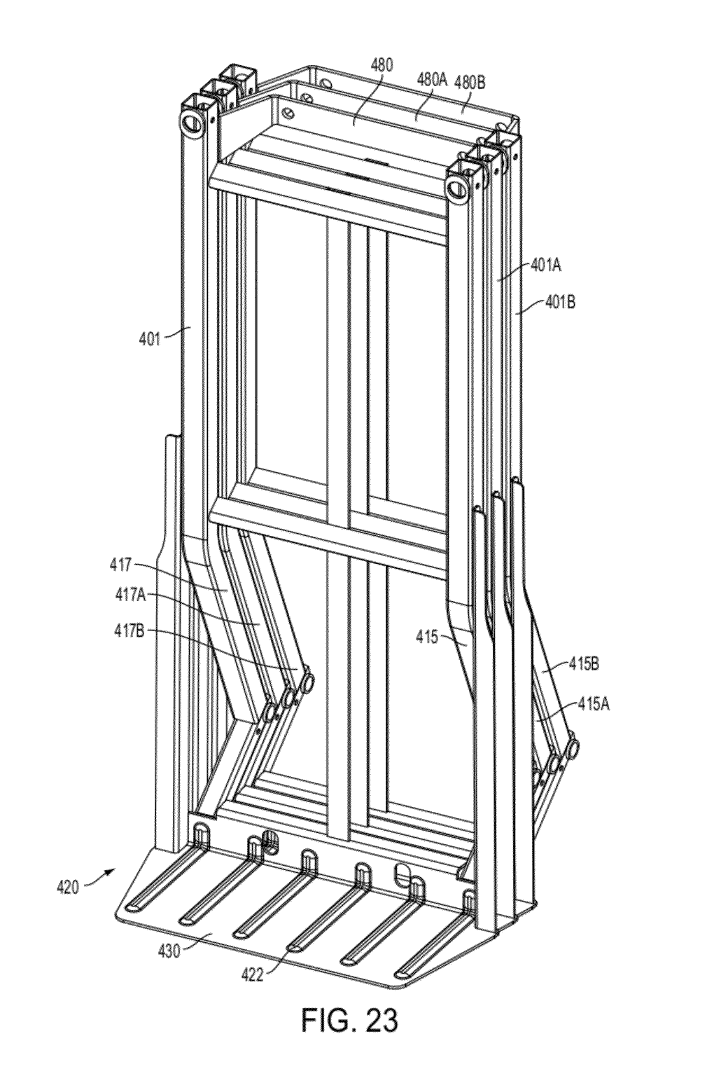

The hand truck 400 may include any suitable type of frame 410. In the embodiment shown in FIGS. 20 and 23, the lower portion of the hand truck's frame 410 is structurally similar to (e.g., identical to) the frame 210 of the embodiment of the hand truck 200 shown in FIG. 7.

As shown in FIGS. 20-22, the first side frame rail 414, in this embodiment, defines a first handle support 478 adjacent (e.g., to) an upper end of the front face of the first side frame rail 414. In this embodiment, the first handle support 478 is adapted to structurally correspond to the bottom end of the first side handle rail 476 of the upper handle assembly 470. When the hand truck 400 is in horizontal orientation (e.g., a cart orientation), the end of the first side handle rail 476 of the upper handle assembly 470 may be inserted into the first handle support 478 such that the first handle support 478 supports the first side handle rail 476 of the upper handle assembly 470 in a substantially vertical orientation.

As shown in FIGS. 20-22, the second side frame rail 416, in this embodiment, includes a second handle support 479 adjacent (e.g., to) an upper end of the front face of the second side frame rail 416. In this embodiment, the second handle support 479 is adapted to structurally correspond to the bottom end of the second side handle rail 474 of the upper handle assembly 470. When the hand truck 400 is in a horizontal orientation (e.g., a cart orientation), the end of the second side handle rail 474 of the upper handle assembly 470 may be inserted into the second handle support 479 such that the second handle support 479 supports the second side handle rail 474 of the upper handle assembly 470 in a substantially vertical orientation.

The various components of the frame 410 may be made of any suitable (preferably sturdy) material (e.g., a suitable metal such as aluminum, or plastic). These components are secured together using any suitable combination of fasteners or welding techniques to provide a rigid frame for the hand truck 400.

Upper Handle Assembly

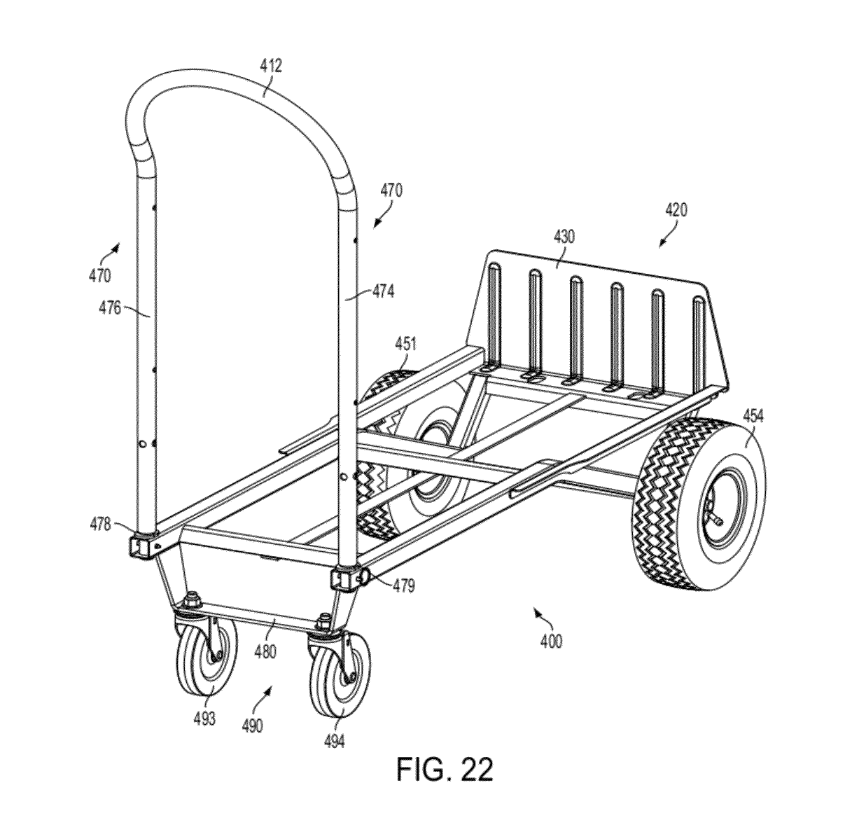

The hand truck 400 may include an upper handle assembly 470. As may be understood from FIGS. 20-22, the upper handle assembly 470 is adapted to be selectively moved from: (1) a vertical position when the hand cart 400 is in a substantially vertical position (FIGS. 20-21) to (2) a vertical position (FIG. 22) when the hand truck 400 is in a horizontal position (e.g., a cart orientation). In the embodiment shown in FIG. 21, the upper handle assembly 470 comprises: (1) a first side handle rail 476; (2) a second side handle rail 474; and (3) a U-shaped connector 412.

The first side handle rail 476 may be made of a substantially straight, elongated tube. In the embodiment shown in FIG. 21, the first side handle rail 476 has a substantially circular (e.g., circular) profile. In alternative embodiments, the first side handle rail 476 may comprise a substantially linear (e.g., linear) tube with any other suitable profile (e.g., a square, rectangular, or oval profile). As shown in FIG. 21, the first side handle rail 476 may be adapted to fit and slide within the frame's first side rail 414. In various embodiments, the dimensions of the inner surface of the first side rail 414 correspond to the dimensions of the outer surface of the first side handle rail 476 such that the first side handle rail 476 can nest within the first side rail 414 with sufficient clearance to facilitate smooth sliding and sufficient snugness to provide rigidity of the hand truck 400 when the upper handle assembly 470 is in an expanded configuration.

The second side handle rail 474 may be made of a substantially straight, elongated tube. In the embodiment shown in FIG. 21, the second side handle rail 474 has a substantially circular (e.g., circular) profile. In alternative embodiments, the second side handle rail 474 may comprise a substantially linear (e.g., linear) tube with any other suitable profile (e.g., a square, rectangular, or oval profile). As shown in FIG. 21, the second side handle rail 474 may be adapted to fit and slide within the frame's second side rail 416. In various embodiments, the dimensions of the inner surface of the second side rail 416 correspond to the dimensions of the outer surface of the second side handle rail 474 such that the second side handle rail 474 can nest within the second side rail 416 with sufficient clearance to facilitate smooth sliding and sufficient snugness to provide rigidity of the hand truck 400 when the upper handle assembly 470 is in an expanded configuration.

In a particular embodiment, the U-shaped connector 412 is adapted to connect the top portions of the first side handle rail 476 and the second side handle rail 474. The U-shaped connector 412 may be adapted for use as a handle.

Nose Plate

In the embodiment shown in FIG. 20, the hand truck 400 has a nose plate 420 that is substantially structurally similar (e.g., identical) to the nose plate 220 of the embodiment of the hand truck 200 shown in FIG. 7.

Primary Wheel Assembly

In the embodiment shown in FIG. 20, the hand truck 400 has a primary wheel assembly 440 that is substantially structurally similar to (e.g., identical to) the primary wheel assembly 240 of the embodiment of a hand truck 200 shown in FIG. 7.

Secondary Wheel Assembly

In particular embodiments, the fourth exemplary hand truck 400 may further comprise a secondary wheel assembly 490. In the embodiment shown in FIG. 22, the secondary wheel assembly 490 is adapted for facilitating the movement of the hand truck 400 relative to a support surface while the hand truck 400 is in a horizontal orientation (e.g., the hand truck is being used as a cart). The secondary wheel assembly 490 may be adapted for cooperating with the primary wheel assembly 440 to facilitate rolling movement of the hand truck 400. In various embodiments, the secondary wheel assembly 490 comprises at least one wheel 493, 494 rotatably attached adjacent (e.g., to) the upper end of the frame 410 when the hand truck 400 is in a substantially vertical orientation. In the embodiment shown in FIG. 21, the secondary wheel assembly 490 comprises a first 491 and a second 492 caster, first and second wheels 493, 494 wheels that are each respectively rotatably mounted to one of the casters 491, 492, and a secondary wheel mount 480.

In particular embodiments, the secondary wheel mount 480 is positioned adjacent (e.g., to) the respective upper ends of the first 414 and second 416 side frame rails and may operate as a connecting member. In the embodiment shown in FIG. 21, the secondary wheel mount 480 extends between the respective upper ends of the first 414 and second 416 side frame rails. In this embodiment, the secondary wheel mount 480 extends substantially perpendicularly (e.g., perpendicularly) between the first 414 and second 416 side frame rails toward the rear of the hand cart 400 when the hand cart 400 is in a substantially vertical position.

Nesting Multiple Fourth Exemplary Hand Trucks

In various embodiments, the body 401 of the fourth exemplary hand truck 400 is adapted to nest with hand truck bodies having a structure that is the same or substantially similar to the structure of the fourth exemplary hand truck body 401 (e.g., with “like” hand truck bodies). As may be understood from FIGS. 23-25, the hand truck body 401 is adapted to nest with like hand truck bodies in substantially the same manner that the hand truck body 201 of FIG. 7 is adapted to nest with like hand truck bodies.

FIGS. 22-25 show three like hand truck bodies 401, 401A-401B in a nested, mating relationship. In this embodiment, the hand truck bodies 401, 401A-401B are dimensioned so that, when the hand truck bodies 401, 401A-401B are positioned in a nested, mating relationship, the exterior face of the secondary wheel mount 480 of the front hand truck (e.g., hand truck body 401) at least substantially mates with (e.g., entirely mates with), the interior face of the of the secondary wheel mount 480A of the rear hand truck body (e.g., hand truck body 401A).

### Fifth Exemplary Hand Truck

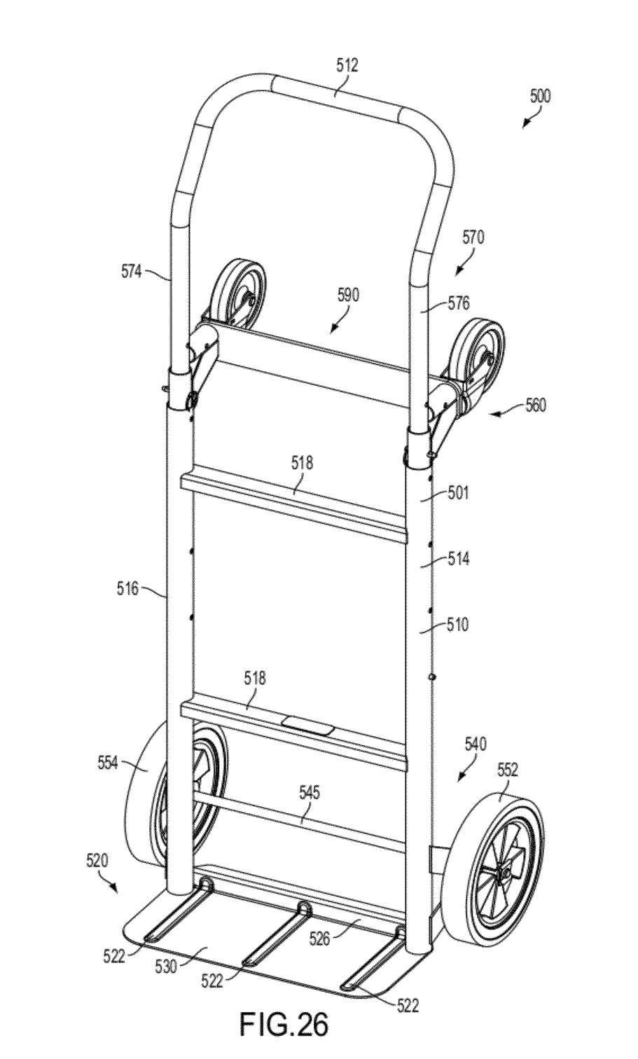

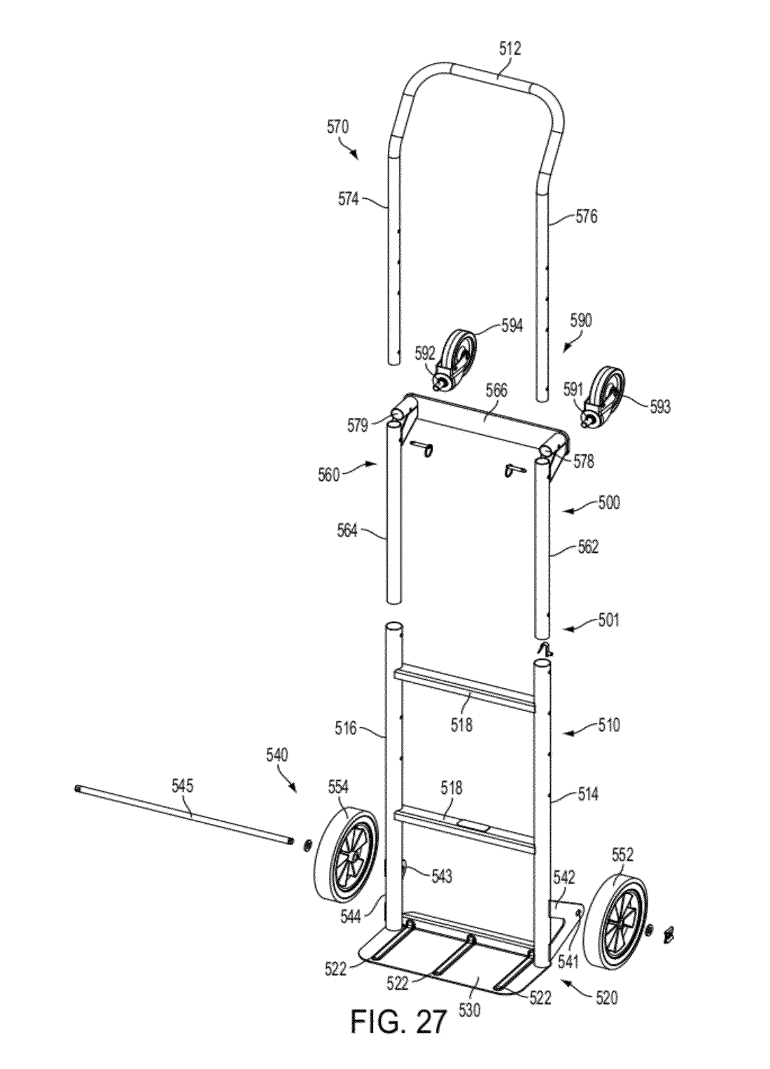

A fifth exemplary hand truck 500 is shown in FIGS. 26-28. As may be understood from these figures, the body 501 of this hand truck is, generally speaking, an expandable, convertible version of the hand truck body 101 shown in FIG. 1. The fifth exemplary hand truck 500 is adapted for conversion between: (1) a vertical hand truck orientation and (2) a horizontal hand cart orientation. As shown in FIG. 27, in this embodiment, the hand truck 500 comprises: (1) a primary frame 510; (2) a secondary frame 560; (3) an upper handle assembly 570; (4) a nose plate 520; (5) a primary wheel assembly 540 (which is shown in FIG. 27 with the wheel assembly's axle 545 and wheels 552, 554 removed for purposes of clarity); and (6) a secondary wheel assembly 590. These various components are discussed in greater detail below.

Primary Frame

The hand truck 500 may include any suitable type of primary frame 510. In the embodiment shown in FIG. 26, this primary frame 510 includes: (1) a first side frame rail 514 (which, in this embodiment, is a substantially straight, elongated frame member that is adapted to stand in a substantially vertical orientation when the hand truck 500 is in an upright position); (2) a second side frame rail 516 (which, in this embodiment, is a substantially straight, elongated frame member that is adapted to stand in a substantially vertical orientation when the hand truck 500 is in an upright position); and (3) a plurality of crossbars 518 that extend between, and physically connect, the first and second side frame rails 514, 516.

The various components of the primary frame 510 may be made of any suitable (preferably sturdy) material (e.g., a suitable metal such as aluminum or steel, or plastic). These components are secured together using any suitable combination of fasteners or welding techniques to provide a rigid frame for the hand truck 500.

Secondary Frame

The hand truck 500 may include any suitable type of secondary frame 560. The secondary frame 560 is adapted for facilitating the selective conversion of the hand truck 500 between; (1) a compact configuration and (2) an expanded configuration. In the embodiment shown in FIG. 27, this secondary frame 560 includes: (1) a first side rail 562; (2) a second side rail 564; and (3) a connecting member 566.

The first side rail 562 may be made of a substantially straight, elongated tube. In the embodiment shown in FIG. 27, the first side rail 562 has a substantially circular (e.g., circular) profile. In alternative embodiments, the first side rail 562 may comprise a substantially linear (e.g., linear) tube with any other suitable profile (e.g., a square, rectangular, or oval profile). As shown in FIG. 27, the first side rail 562 may be adapted to fit within the primary frame's 510 first side frame rail 514. As shown in FIG. 27, the first side rail 562 has a cross sectional profile that corresponds to the cross sectional profile of the first side frame rail 514. In various embodiments, the dimensions of the inner surface of the first side frame rail 514 correspond to the dimensions of the outer surface of the first side rail 562 such that the first side rail 562 can nest within the first side frame rail 514 with sufficient clearance to facilitate smooth sliding and sufficient snugness to provide rigidity of the hand truck 500 when in an expanded configuration.

The second side rail 564 may be made of a substantially straight, elongated tube. In the embodiment shown in FIG. 27, the second side rail 564 has a substantially circular (e.g., circular) profile. In alternative embodiments, the second side rail 564 may comprise a substantially linear (e.g., linear) tube with any other suitable profile (e.g., a square, rectangular, or oval profile). As shown in FIG. 27, the second side rail 564 may be adapted to fit and slide within the primary frame's 510 second side frame rail 516. As shown in FIG. 27, the second side rail 564 has a cross sectional profile that corresponds to the cross sectional profile of the second side frame rail 516. In various embodiments, the dimensions of the inner surface of the second side frame rail 516 correspond to the dimensions of the outer surface of the second side rail 564 such that the second side rail 564 can nest within the second side frame rail 516 with sufficient clearance to facilitate smooth sliding and sufficient snugness to provide rigidity of the hand truck 500 when in an expanded configuration.

In particular embodiments, the connecting member 566 is adapted to connect the top portions of the first side rail 562 and the second side rail 564. The connecting member 566 may be made of any suitable (preferably sturdy) material (e.g., a suitable metal such as steel or aluminum, or plastic). The connecting member 566 is adapted to substantially mate with (e.g., entirely mate with) a like connecting member 566 of a like hand truck body 501.

Upper Handle Assembly

The hand truck 500 may include an upper handle assembly 570. As may be understood from FIG. 27, the upper handle assembly 570 is adapted to be selectively moved from: (1) a vertical position when the hand truck 500 is in a substantially vertical position to (2) a vertical position when the hand truck 500 is in a horizontal position (e.g., a cart orientation). In the embodiment shown in FIG. 27, the upper handle assembly 570 comprises: (1) a first side handle rail 576; (2) a second side handle rail 574; (3) an upper connecting member 512; and (4) first 578 and second 579 handle supports.

The first side handle rail 576 may be made of a substantially straight, elongated tube. In the embodiment shown in FIG. 27, the first side handle rail 576 has a substantially circular (e.g., circular) profile. In alternative embodiments, the first side handle rail may comprise a substantially linear (e.g., linear) tube with any other suitable profile (e.g., a square, rectangular, or oval profile). As shown in FIG. 27, the first side handle rail 576 may be adapted to fit and slide within the first side rail 562. As shown in FIG. 27, the first side handle rail 576 has a cross sectional profile that corresponds to the cross sectional profile of the first side rail 562. In various embodiments, the dimensions of the inner surface of the first side rail 562 correspond to the dimensions of the outer surface of the first side handle rail 576 such that the first side handle rail 576 can nest within the first side rail 562 with sufficient clearance to facilitate smooth sliding and sufficient snugness to provide rigidity of the hand truck 500 when the hand truck 500 is in an expanded configuration.

The second side handle rail 574 may be made of a substantially straight, elongated tube. In the embodiment shown in FIG. 27, the second side handle rail 574 has a substantially circular (e.g., circular) profile. In alternative embodiments, the second side handle rail 574 may comprise a substantially linear (e.g., linear) tube with any other suitable profile (e.g., a square, rectangular, or oval profile). As shown in FIG. 27, the second side handle rail 574 may be adapted to fit and slide within the second side rail 564. As shown in FIG. 27, the second side handle rail 574 has a cross sectional profile that corresponds to the cross sectional profile of the second side rail 564. In various embodiments, the dimensions of the inner surface of the second side rail 564 correspond to the dimensions of the outer surface of the second side handle rail 574 such that the second side handle rail 574 can nest within the second side rail 564 with sufficient clearance to facilitate smooth sliding and sufficient snugness to provide rigidity of the hand truck 500 when the hand truck 500 is in an expanded configuration.

The secondary frame assembly 560 may further comprise a first 578 and a second 579 handle support. The first 578 and second 579 handle supports are adapted to receive the respective ends of the first 576 and second 574 side handle rails when the hand truck 500 is in the horizontal, cart orientation. As shown in FIG. 27, the second handle support 579 has a cross sectional profile that corresponds to the cross sectional profile of the second side handle rail 574. Similarly, the first handle support 578 has a cross-sectional profile that corresponds to the cross sectional profile of the first side handle rail 576. The first 578 and second 579 handle supports are adapted to support the upper handle assembly 570 when the hand truck 500 is in the horizontal cart orientation.

In a particular embodiment, the upper connecting member 512 is adapted to connect the top portions of the first side handle rail 576 and the second side handle rail 574. The upper connecting member 512 may be adapted for use as a handle.

Nose Plate

In the embodiment shown in FIG. 26, the hand truck 500 has a nose plate 520 that is structurally similar (e.g., identical) to the nose plate 120 of the first embodiment of the hand truck 100 shown in FIG. 1.

Primary Wheel Assembly

In the embodiment shown in FIG. 26, the hand truck 500 has a primary wheel assembly 540 that is structurally similar (e.g., identical) to the wheel assembly 140 of the first embodiment of the hand truck 100 shown in FIG. 1.

Secondary Wheel Assembly

In particular embodiments, the fifth exemplary hand truck 500 may further comprise a secondary wheel assembly 590. In the embodiment shown in FIG. 27, the secondary wheel assembly 590 is adapted for facilitating the movement of the hand truck 500 relative to the support surface while the hand truck 500 is in a horizontal orientation (e.g., when the hand truck 500 is being used as a cart). The secondary wheel assembly 590 may be adapted for cooperating with the primary wheel assembly 540 to facilitate rolling movement of the hand truck 500. In various embodiments, the secondary wheel assembly 590 comprises at least one wheel that is rotatably attached adjacent the upper end of the hand truck 500 when the hand truck 500 is in a substantially vertical position. In various embodiments, the secondary wheel assembly 590 is attached to the underside of the connecting member 566 when the hand truck 500 is in the horizontal orientation. In the embodiment shown in FIG. 27, the secondary wheel assembly 590 comprises first and second casters 591, 592, and first and second wheels 593, 594 that are each rotatably attached to one of the respective casters 591, 592.

Converting Fifth Exemplary Hand Truck

In various embodiments, the hand truck 500 is adapted for selective conversion between: (1) a vertical operating arrangement and (2) a horizontal operating arrangement. In various embodiments, while in the horizontal position, the hand truck 500 is further adapted for selective conversion between: (1) a compact operating arrangement and (2) an expanded operating arrangement. In alternative embodiments, the hand truck 500 is further adapted for selective conversion between: (1) a compact operating arrangement and (2) an expanded operating arrangement while in the vertical position.

As may be understood from FIG. 27, to convert the hand truck 500 from the vertical operating arrangement to the horizontal operating arrangement, a user may lay the hand truck 500 on the ground so that the primary wheel assembly 540 and secondary wheel assembly 590 are both in contact with a support surface supporting the hand truck 500. Once the hand truck 500 is in the horizontal operating arrangement, the user may remove the upper handle assembly 570 from the secondary frame assembly 560 and insert the first side handle rail 576 into the first handle support 578 and the second side handle rail 574 into the second handle support 579. The user may then selectively reposition the secondary frame assembly 560 relative to the primary frame assembly 510. Sliding the secondary frame 560 relative to the hand truck's base portion allows the user to selectively adjust the hand truck 500 between, for example, a compact operating arrangement and an extended operating arrangement. The secondary frame 560 may be locked in the extended operating arrangement with any suitable locking mechanism (e.g., a pin).

In additional embodiments, the secondary frame 560 may be arranged into its extended arrangement while the hand truck 500 is in its vertical operating arrangement.

Nesting Multiple Fifth Exemplary Hand Truck Bodies

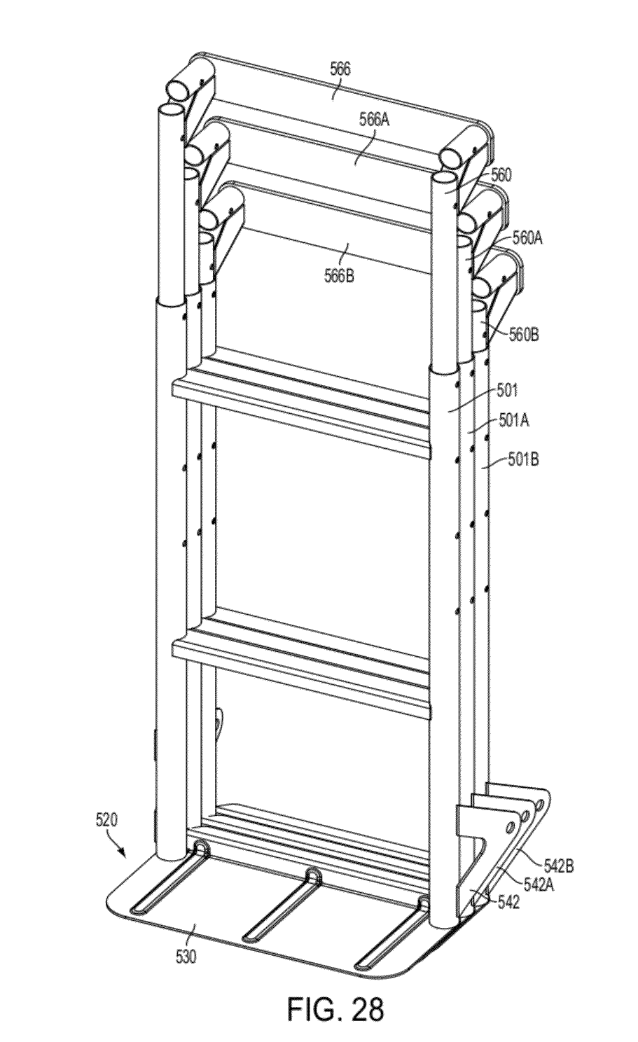

In various embodiments, the body 501 of the fifth exemplary hand 500 truck is adapted to nest with hand truck bodies having a structure that is the same or substantially similar to the structure of the fifth exemplary hand truck body 501 (e.g., with “like hand truck bodies). As may be understood from FIG. 28, the hand truck body 501 is adapted to nest its lower portion with the lower portion of like hand truck bodies in substantially the same manner that the hand truck body 101 of FIG. 1 is adapted to nest its lower portion with the lower portion of like hand truck bodies.

FIG. 28 shows three like hand truck bodies 501, 501A-501B in a nested, mating relationship. As shown in this figure, in this embodiment, the hand truck bodies 501, 501A-501B are dimensioned so that, when the hand truck bodies 501, 501A-501B are positioned in a nested, mating relationship, the secondary frame 560 of the front hand truck body 501 at least substantially mates with (e.g., entirely mates with) the secondary frame 560A of the rear hand truck body 501A when the secondary frame 560 of the front hand truck body 510 is extended so that the bottom of the connecting member 566 is at least positioned above the connecting member 566A of the rear hand truck body 501A to allow the front hand truck body 501 and the rear hand truck body 501A to stand nested in a substantially vertical position. In various embodiments, the bottom of the connecting member 566 of the front hand truck body 501 is extended to substantially the same height as the top of the connecting member 566A of the rear hand truck body 501A.

As shown in FIG. 28, when the fifth exemplary hand truck bodies 501, 501A-B are in a nested, mating relationship, the secondary frames 560, 560A-B are in a stair-stepped relationship with one another. In this stair-stepped relationship: (1) the connecting members 566, 566A are substantially parallel to (e.g., parallel to) one another; and (2) the secondary frames 560 of hand truck bodies 501, 501A-B are locked in positions of progressively increasing lengths.

As may be understood from FIG. 28, the rear-most hand truck body 501B in the nested, mating relationship has a secondary frame 560B that is in the least extended position of the various nested hand truck bodies 501, 501A. The hand truck body 501A immediately in front of the rear-most hand truck body 501B has a secondary frame 560A that is locked at a length of extension sufficiently longer than the length of extension of the rear hand truck body 501B to allow the secondary frame 560A of the hand truck body 501A immediately in front of the rear most hand truck body 501B to nest in a stair-step relationship with the secondary frame 560B of the rearmost hand truck body 501B when both hand truck bodies 501A, 501B are in a substantially vertical orientation.

As may be understood from FIG. 28, the secondary frame 560, 560A-B of each successively nested hand truck body 501, 501A-B is locked in an increasingly extended position. The three nested hand truck bodies 501, 501A-B are all in a substantially vertical orientation. In the nested, mating relationship shown in FIG. 28, the first hand truck body 501B has a secondary frame 560B that is in an unextended position. The second, middle hand truck body 501A has a secondary frame 560 that is extended to a first distance where the secondary frame 560A of the second hand truck body 501A is in a nested, stair-step relationship with the secondary frame 560B of the first hand truck body 501B. In the nested, mating relationship shown in FIG. 28, a third hand truck body 501 is the front hand truck body 501 of three like hand truck bodies 501, 501A-B that are positioned in a nested, mating relationship. The secondary frame 560 of the third hand tuck body 501 is extended to a second distance where the secondary frame 560 of the third hand truck body 501 is in a nested, stair-step relationship with the secondary frame 560A of the second hand truck body 501A.

### Sixth Exemplary Hand Truck

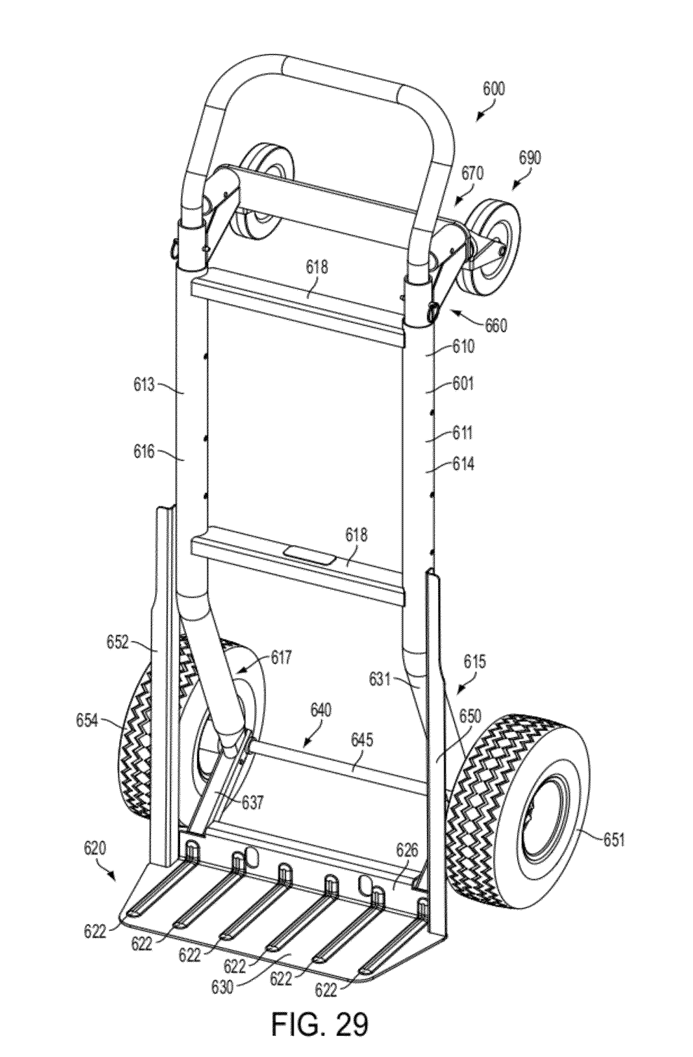

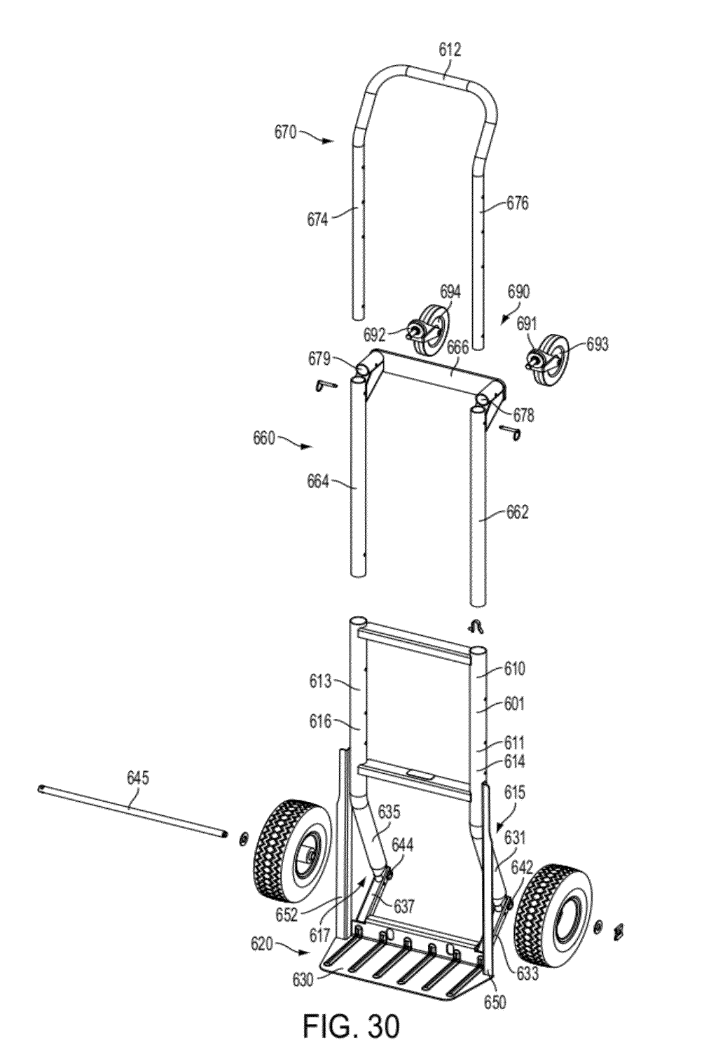

An exemplary hand truck according to a further embodiment is shown in FIGS. 29-31. In this embodiment, the hand truck 600 comprises: (1) a primary frame 610; (2) a secondary frame 660; (3) an upper handle assembly 670; (4) a nose plate 620; (5) a primary wheel assembly 640; and (6) a secondary wheel assembly 690. These various components are discussed in greater detail below.

Primary Frame

The hand truck 600 has a primary frame 610 that is structurally similar (e.g., identical) to the frame 210 of the embodiment of a hand truck 200 shown in FIG. 7 without the handle 260 or upper connecting portion 212.

Secondary Frame

The hand truck 600 has a secondary frame 660 that is substantially structurally similar (e.g., identical) to the secondary frame 560 of the embodiment of a hand truck 500 shown in FIG. 27.

Upper Handle Assembly

The hand truck 600 has an upper handle assembly 670 that is substantially structurally similar (e.g., identical) to the upper handle assembly 570 of the embodiment of a hand truck 500 shown in FIG. 27.

Nose Plate

The hand truck 600 has a nose plate 620 that is substantially structurally similar (e.g., identical) to the nose plate 220 of the embodiment of a hand truck 200 shown in FIG. 7.

Primary Wheel Assembly

The hand truck 600 has a primary wheel assembly 640 that is substantially structurally similar (e.g., identical) to the wheel assembly 240 of the embodiment of a hand truck 200 shown in FIG. 7.

Secondary Wheel Assembly

The hand truck 600 has a secondary wheel assembly 690 that is substantially structurally similar (e.g., identical) to the secondary wheel assembly 590 of the embodiment of a hand truck 500 shown in FIG. 27.

Converting Sixth Exemplary Hand Truck

In various embodiments, the hand truck 600 is adapted to be selectively converted between a vertical and a horizontal orientation, and also selectively extended and retracted in the manner described above in regard to the hand truck 500 shown in FIG. 27.

Nesting Multiple Sixth Exemplary Hand Truck Bodies

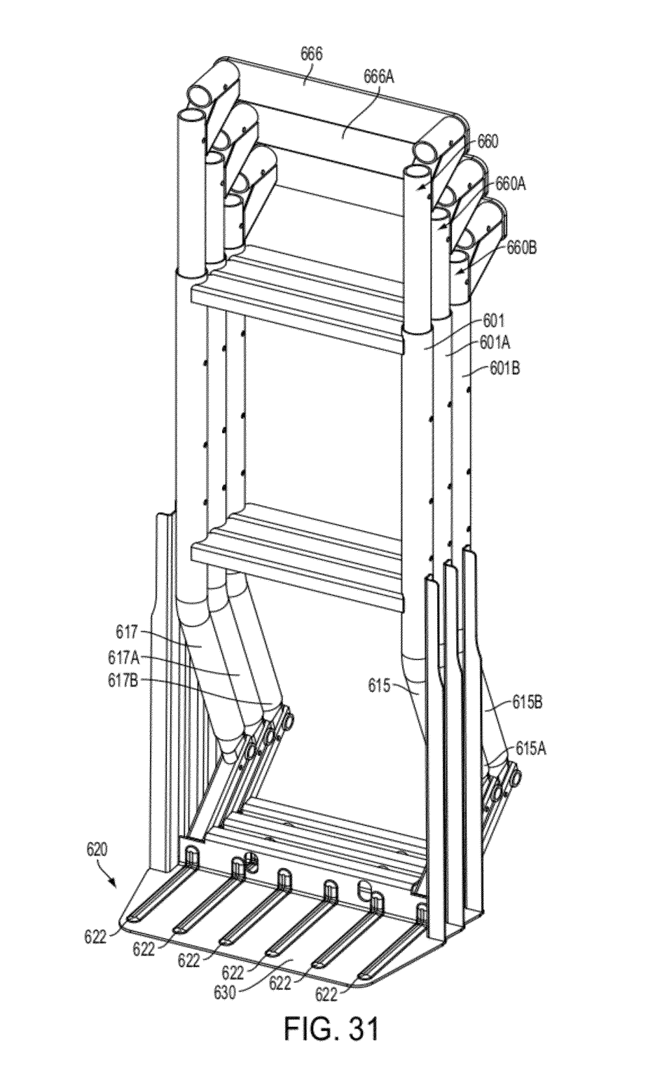

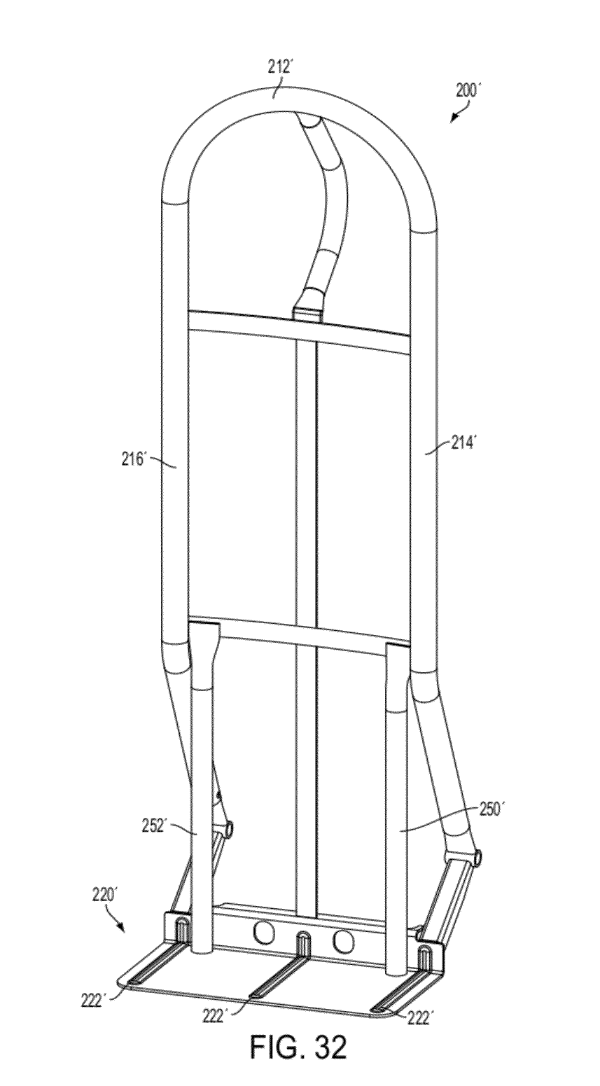

FIG. 31 shows three like hand truck bodies 601, 601A-601B in a nested, mating relationship. As may be understood from this figure, in this embodiment, the lower portion of the hand truck body 601 is adapted to nest with the lower portion of like hand truck bodies in substantially the same manner that the lower portion of the hand truck body 201 of FIG. 7 is adapted to nest with the lower portion of like hand truck bodies.

Similarly, as shown in FIG. 31, the hand truck bodies 601, 601A-601B are dimensioned so that, when the hand truck bodies 601, 601A-601B are positioned in a nested, mating relationship, the secondary frame 660 of the front hand truck body 601 at least substantially mates with (e.g., entirely mates with) the secondary frame 660A of the rear hand truck body 601A in substantially the same manner that the secondary frame 560 of the hand truck body 501 in FIGS. 26-28 mates with a like secondary frame 560A of a like hand truck body 501A.

Exemplary Hand Truck Shipping Description

As shown in various figures referenced above, when a plurality of hand truck bodies are positioned in a nesting relationship, the hand truck bodies can fit in a compact space. This may, for example, facilitate shipping a large number of the hand truck bodies in a single shipping container.

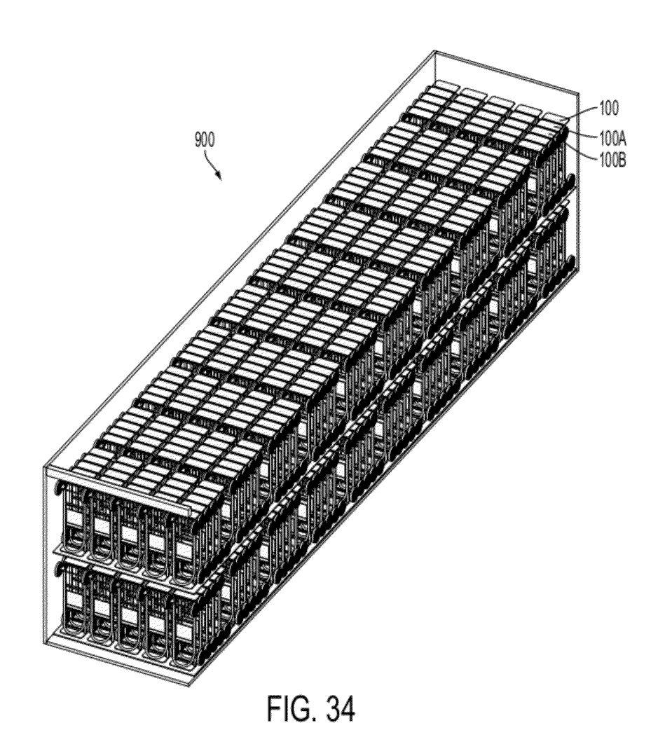

FIGS. 34-36 show various hand trucks loaded into a shipping container 900. As may be understood form FIG. 34, a plurality of nested hand trucks 101, 101A can be fit compactly within a shipping container 900. Because hand trucks are in a nested relationship, they may fit in a compact space, allowing efficient shipment of the hand trucks by: (1) placing a plurality of hand truck bodies in a nested relationship; (2) placing the plurality of nested hand truck bodies in a shipping container (such as a freight container or any other suitable container); (3) placing the hand trucks' respective wheels, axles, and handles (if applicable) in the shipping container; (4) transporting the shipping container, which contains the plurality of nested hand truck bodies and their respective wheels, axles, and handles (if applicable) from an origin to a destination; (5) unpacking the shipping container (e.g., at the destination or other suitable location); and (6) assembling the plurality of hand trucks (e.g., at the destination or other suitable location) by moving the hand truck bodies out of the nested relationship (e.g., one at a time) and assembling each respective hand truck body into a completed hand truck by attaching a respective axle and pair of wheels to each respective hand truck body and inserting the upper handle assembly into the secondary frame if applicable.

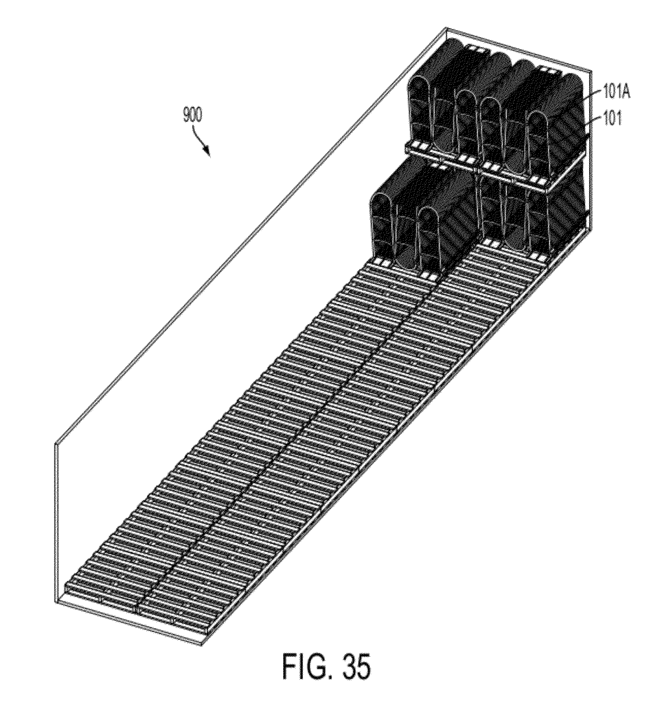

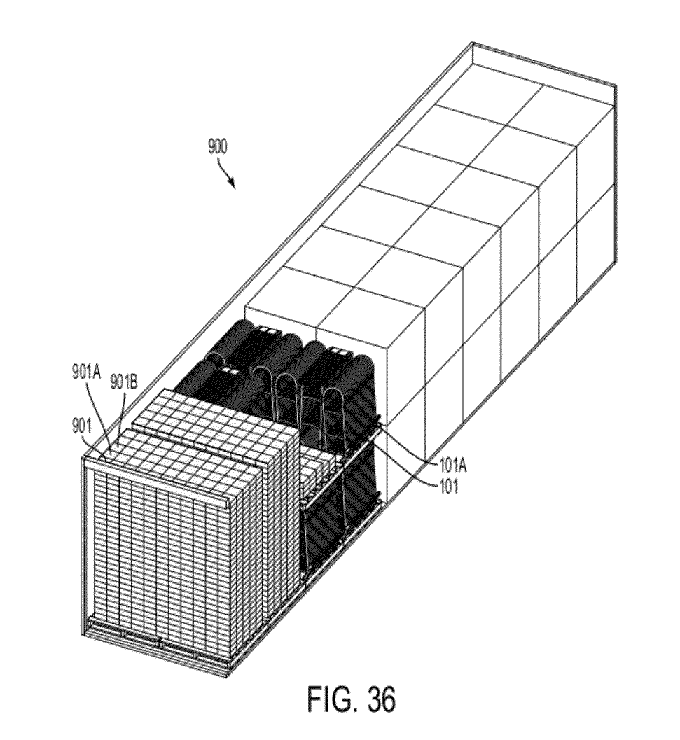

FIG. 34 shows a plurality of hand truck bodies 101, 101A-B in a nested, mating relationship when the hand truck bodies 101, 101A-B are placed in a shipping container 900. FIG. 35 shows a shipping container 900 packed with the hand truck bodies 101, 101A in nested relationships along with accompanying wheel kits 901, 901A containing wheels and axles. In the shipping container 900 shown in FIG. 35, over 3,000 hand trucks are packed in the container along with their accompanying wheel kits 901, 901A-B. The shipping container 900 in FIG. 36 is packed with fully assembled hand trucks 100, 100A-B. As may be understood from FIG. 36, this shipping container 900 holds many fewer (approximately 1,000) hand trucks than the shipping container 900 of FIG. 35.

Hand Truck with Wheel Assembly Adapted for Toolless Assembly

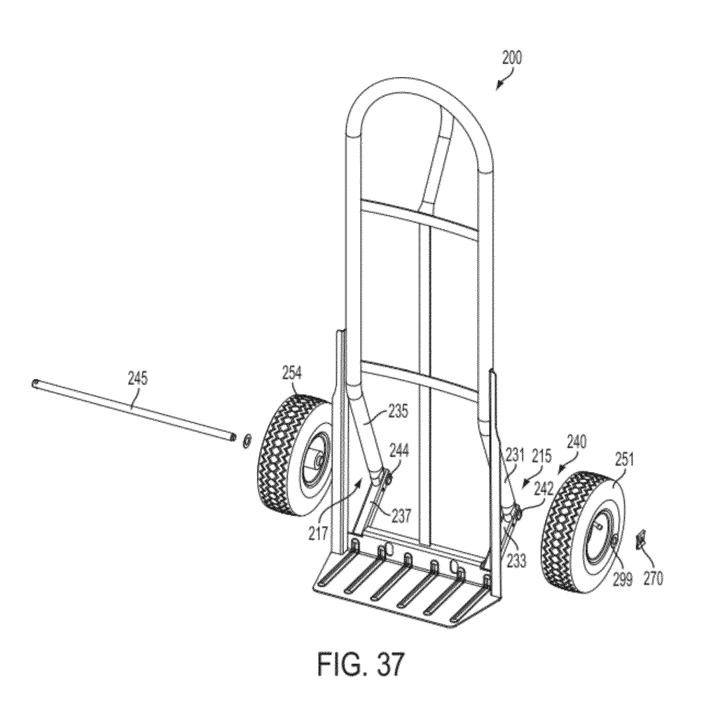

FIG. 37 shows a hand truck 200 according to a particular embodiment in an exploded view of the hand truck's wheel assembly 240. In the embodiment shown in this figure, the wheel assembly 240 includes: (1) an axle 245; (2) a clip 270; (3) a pair of wheels 251, 254; and (4) a first and second axle support 242, 244. These various components are discussed in greater detail below.

Axle

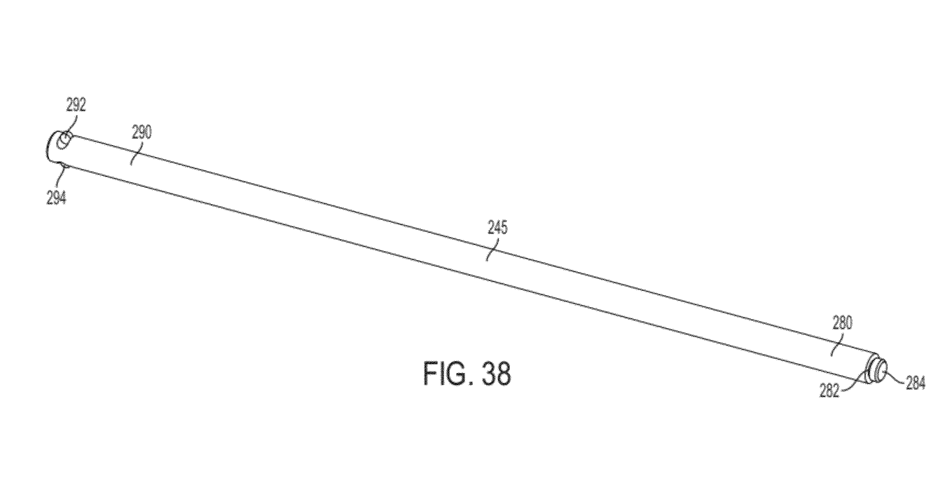

In the embodiment shown in FIG. 38, the axle 245 comprises: (1) a first end 290 that comprises a first and a second projection 292, 294 that each extend outwardly from an outer surface of the axle 235; and (2) a second end 280 that defines an axle recess 282 in the surface of the axle 245 and comprises an end piece 284 disposed adjacent the recess 282.

First End

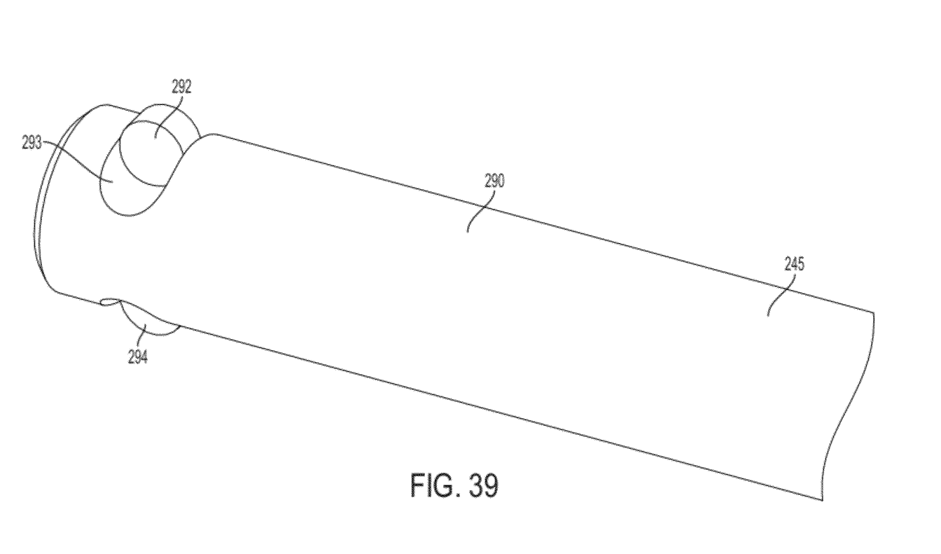

FIG. 39 shows a detail view of the axle's first end 290. As shown in this figure, the first projection 292 comprises a substantially circular (e.g., circular) protrusion that is disposed at least partially within a first recess 293 defined adjacent the axle's first end 290. As may be understood from this figure, the first recess 293 is substantially perpendicular (e.g., perpendicular) to the axle 245 and has a substantially semi-circular (e.g., semi-circular) profile that has a radius that corresponds to a radius of the first projection 292. In certain embodiments, at least about half of the profile of the first projection 292 is disposed within the recess, and the remaining profile of the first projection 292 extends beyond the surface of the axle 245.

In the embodiment shown in FIG. 39, the second projection 294 is substantially structurally similar (e.g., identical) to the first projection 292 and disposed on an opposing side of the hand truck's axle 245 from the first projection 292. In particular embodiments, the first and second projections 292, 294 are substantially co-planer (e.g., co-planar) and disposed substantially parallel (e.g., parallel) to the hand truck's axle 245.

Second End

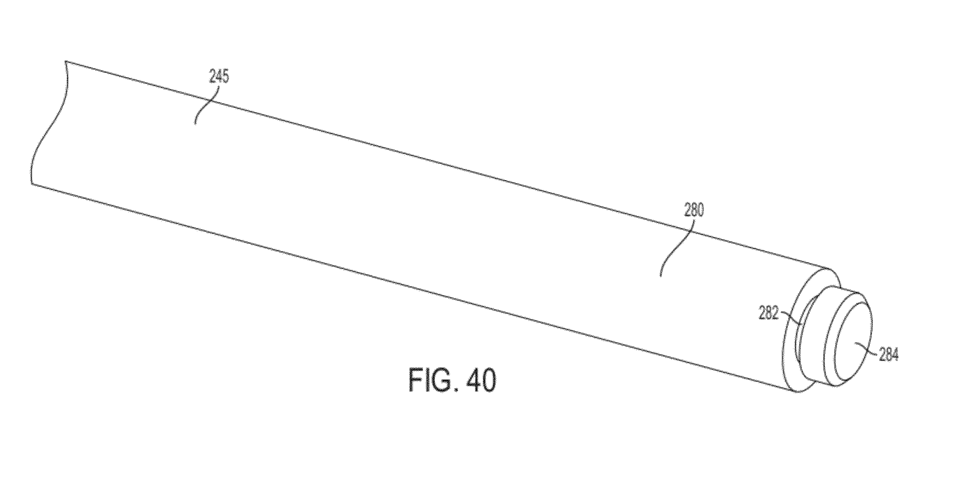

FIG. 40 shows a detail view of the axle's second end 280. As may be understood from this figure, the axle 245 defines an axle recess 282 adjacent the axle's second end 280. In particular embodiments, the portion of the axle 245 that defines the axle recess 282 has a radius that is less than the axle's radius. In various embodiment, the axle recess 282 extends around the axle's circumference substantially perpendicular (e.g., perpendicular) to the axle's central axis.

As shown in FIG. 40, in various embodiments, the axle's end piece 284 is a substantially cylindrical protrusion that extends adjacent the axle's second end 284. In particular embodiments, the axle's end piece has a substantially circular (e.g., circular) cross section, has a radius that is less than the axle's radius, and defines a beveled edge along the circumference of the edge piece's outer surface.

Clip

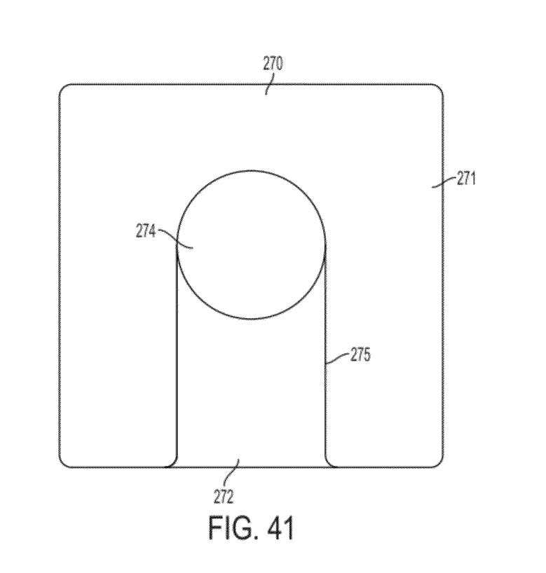

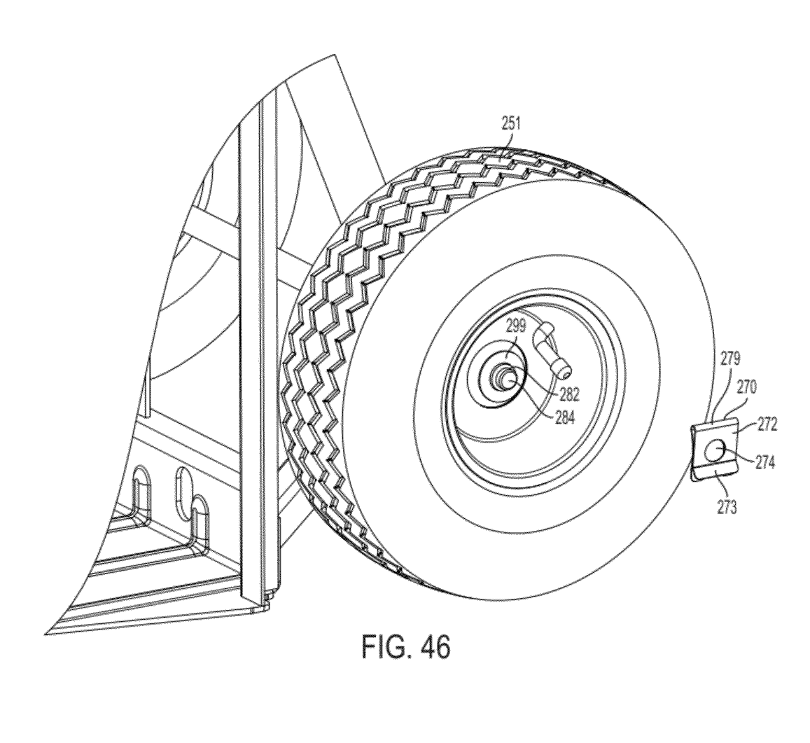

FIG. 41 shows a rear detail view of the wheel assembly's clip 270, and FIG. 46 shows the clip 270 from a front perspective view. As shown in these figures, the clip 270 comprises: (1) a first clip portion 271 defining an elongated channel 275; (2) a second clip portion 272 defining an opening 274 (e.g., a substantially circular opening); (3) and a biasing mechanism 279 for biasing the second clip portion 272 toward a particular home position.

First Clip Portion

As shown in FIG. 41, the first clip portion 271 has a substantially rectangular (e.g., rectangular) profile. In particular embodiments, the first clip portion 271 may have a substantially square (e.g., square) profile and be substantially planar (e.g., planar). In certain embodiments, the thickness of the first clip portion 271 substantially corresponds to the width of the axle recess 282.

In particular embodiments, the first clip portion 271 defines an elongated channel 275, which has a substantially rectangular (e.g., rectangular) profile having a substantially semi-circular (e.g., semi-circular) arc along the upper side of the substantially rectangular (e.g., rectangular) profile. In the embodiment shown in FIG. 41, the semi-circular portion of the elongated channel 275 has a radius that at least generally corresponds to the radius of the portion of the axle 245 that defines the axle recess 282.

Second Clip Portion

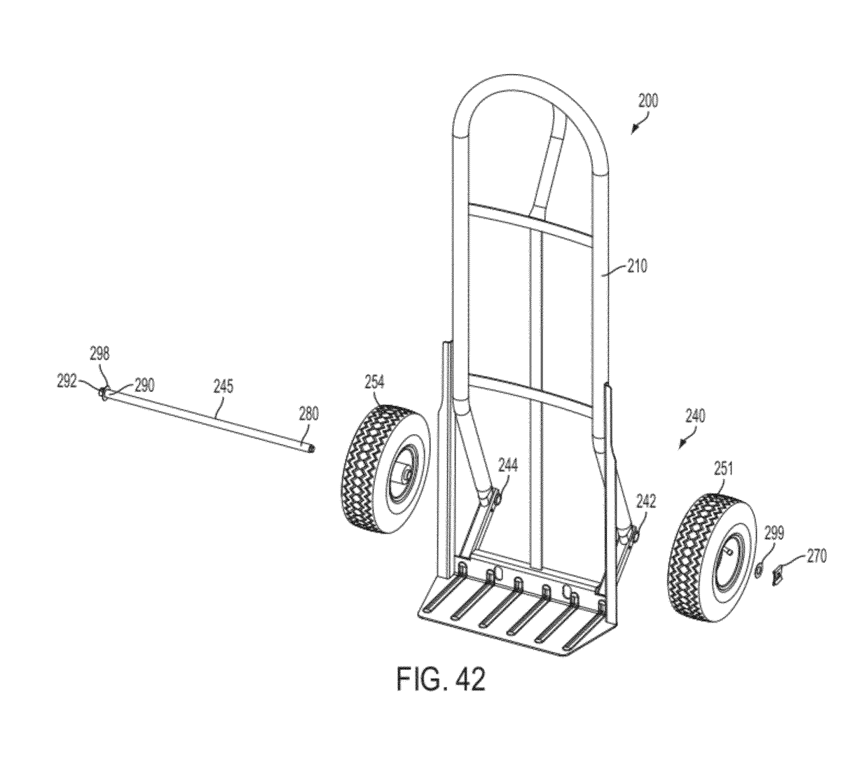

As shown in FIG. 46, the second clip portion 272 has a substantially rectangular (e.g., rectangular) profile. In particular embodiments, the second clip portion 272 may have a substantially square (e.g., square) profile and may be substantially planar (e.g., planar). In the embodiment shown in FIG. 46, the second clip portion 272 comprises an outwardly turned portion 273 disposed adjacent a lower end of the second clip portion 272. In particular embodiments, the outwardly turned portion 273 forms an angle of between about 90 degrees and about 180 degrees with the remainder of the second clip portion 272. In the embodiment shown in FIG. 42, the outwardly turned portion 273 forms an angle of about 150 degrees with the remainder of the second clip portion 272.

In particular embodiments, the second clip portion's opening 274 is substantially circular (e.g., circular) and defined substantially centered (e.g., centered) on the second clip portion 272. In particular embodiments, the second clip portion's opening is at least partially aligned (e.g., aligned) with at least a portion of the first clip portion's elongated channel 275. In certain embodiments, the radius of the second clip portion's opening 274 corresponds generally to the radius of the axle's end piece 284.

In particular embodiments, the first and second clip portions 271, 272 may be substantially parallel (e.g., parallel) and substantially co-facing (e.g., co-facing). In certain embodiments, the first and second clip portions 271, 272 may be portions of a substantially continuous (e.g., continuous) piece of material, which may include any suitable material (e.g., a suitable metal such as aluminum or steel, or plastic).

Biasing Mechanism

In the embodiment shown in FIG. 46, the biasing mechanism 279 comprises a rolled connection between an upper edge of the first and second clip portions 271, 272. In particular embodiments, the biasing mechanism may be adapted for biasing the second clip portion 272 toward a particular home position. The particular home position may be, for example, a position adjacent the first clip portion 271. In particular embodiments, the biasing mechanism may include a torsion spring that may be disposed adjacent an upper edge of the first and second clip portions 271, 272. In other embodiments, the biasing mechanism may include any other suitable mechanism for biasing the second clip portion 272 toward the particular home position (e.g., a linear spring).

Pair of Wheels

As shown in FIG. 37, the wheel assembly 240 includes any suitable first and second wheel 251, 254. In particular embodiments, the wheels 251, 254 may be adapted to at least partially support the hand truck 200 when attached to the hand truck 200 and may be adapted to facilitate the rolling movement of the hand truck 200 over a support surface.

Axle Supports

In the embodiment shown in FIG. 37, the wheel assembly 240 also includes a first and second axle support 242, 244 that are substantially structurally similar (e.g., identical) to the first and second axle support 242, 244 of the embodiment of a hand truck 200 shown in FIG. 7.

Exemplary Steps for Assembling a Wheel Assembly Substantially without the Use of Tools

FIGS. 42-48 show exemplary steps for assembling a hand truck's wheels 251, 254, axle 245 and clip 270 in order to maintain the hand truck's wheels 251, 254 adjacent (e.g., to) a lower portion of the hand truck 200. As may be understood from FIG. 42, in particular embodiments, the wheel assembly 240 may be adapted to allow a user to assemble the wheel assembly 240 substantially without the use of tools by first positioning the first wheel 251 adjacent the first axle support 242 and placing the second wheel 254 adjacent the second axle support 244.

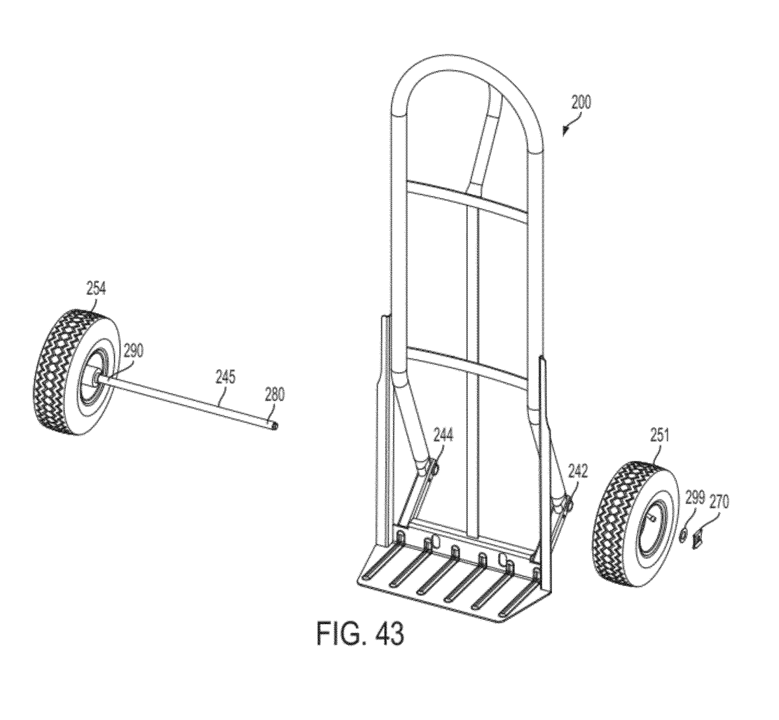

As shown in FIG. 42, in particular embodiments, the wheel assembly 240 may further comprise a first and second washer 298, 299. In such embodiments, a user may slide the first washer 298 over the axle's second end 280 and along the length of the axle 245 until at least a portion of the first washer 298 engages at least a portion of the axle's first and second projections 292, 294. A user may then, as shown in FIG. 43, slide the second wheel 254 over the axle's second end 280 along the length of the axle 245 until at least a part of the second wheel 254 engages at least a part of the first washer 298. In embodiments of the hand truck 200 without washers 298, 299, the user may slide the second wheel 254 along the length of the axle 245 until at least a part of the second wheel 254 engages at least a part of the first and second protrusions 292, 294.

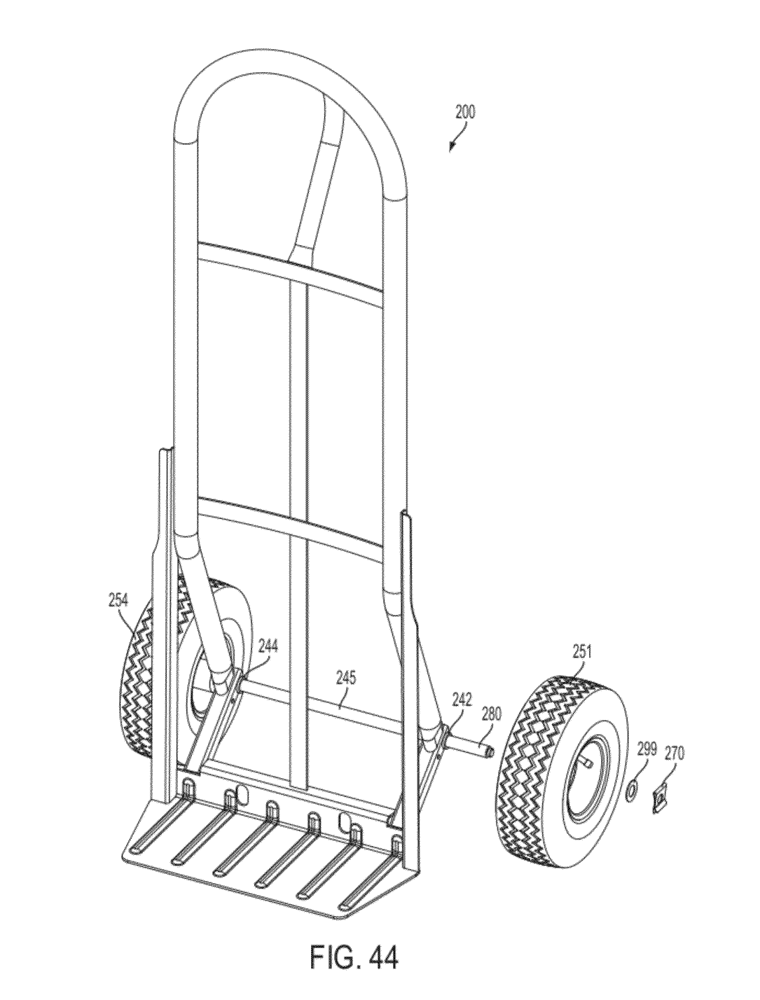

As may be understood from FIG. 44, a user may then insert the axle's second end 280 through the second and first axle supports 244, 242 such that the axle's second end 280 extends a distance beyond the first axle support 242. A user may then place the first wheel 251 on the axle's second end 280.

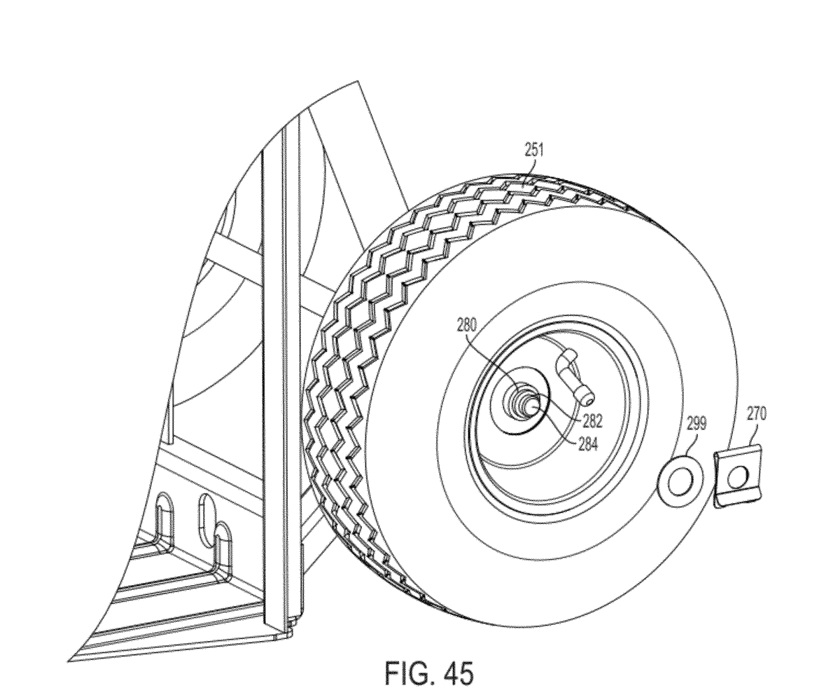

As may be understood from FIG. 45, when the first wheel 251 is disposed on the axle's second end 280, the axle recess 282 and axle's end piece 284 extend beyond the outside edge of the first wheel 251. FIG. 46 shows the second washer 299 disposed on the axle's second end 280 after a user has placed the second washer 299 on the axle's second end 280.

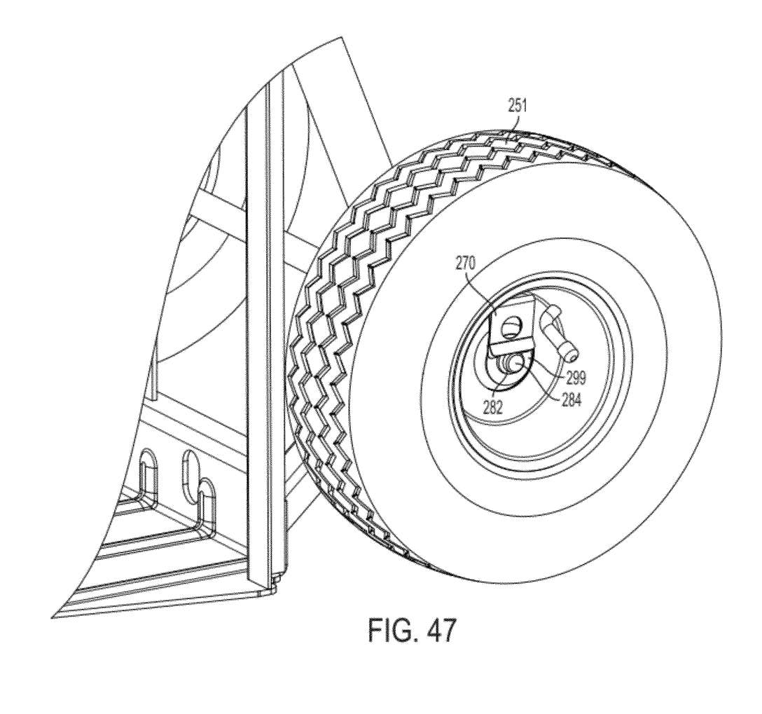

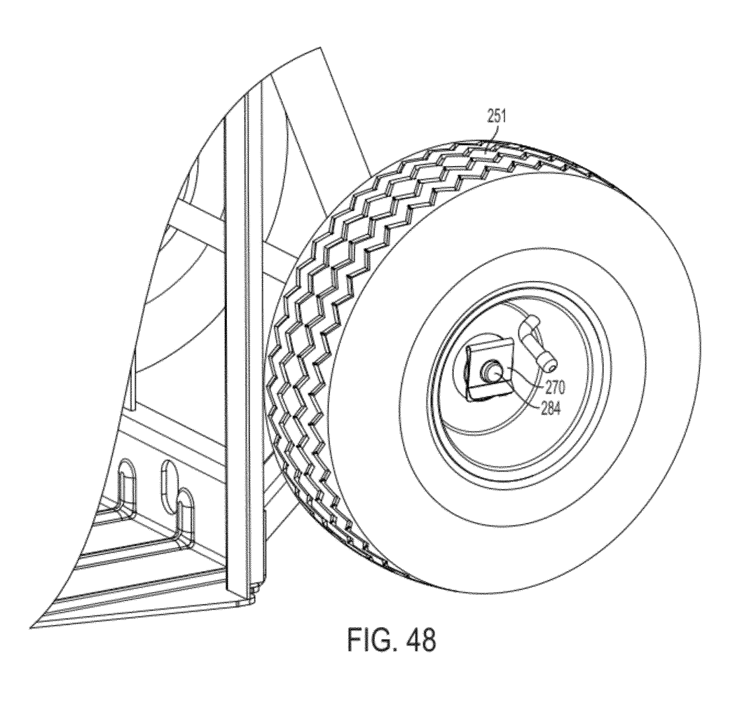

FIGS. 47-48 show the steps of attaching the clip 270 to maintain the first wheel 251 in a substantially fixed (e.g., fixed) lateral position adjacent the hand truck 200. In particular embodiments, the clip 270 is adapted to attach adjacent the axle's second end 290 and maintain the first wheel 251 adjacent the axle's second end 290. As may be understood from FIG. 47, a user may align the first clip portion's elongated channel 275 with the axle recess 282. As the user slides the clip 270 adjacent the axle's second end 280, at least a portion of the first clip portion 271 that defines the elongated channel 275 engages at least a portion of the axle recess 282, and the clip's outwardly turned portion 273 engages the axle's end piece 284, which exerts an outward force on the outwardly turned portion 273.

As the user continues to slide the clip 270, the outward force that the axle's end piece 284 exerts on the clip's outwardly turned portion 273 causes the second clip portion 272 to bend away from the first clip portion 271 until the clip's outwardly turned portion 273 slides at least fully past the axle's end piece 284 allowing the biasing mechanism 279 to bias the second clip portion 272 back to the home position shown in FIG. 48. In the home position, at least a portion of the axle's end piece 284 is disposed within the clip's opening 274 and at least a portion of the second clip portion 272 that defines the clip's opening 274 engages an outside portion of the axle's end piece 284. In particular embodiments, the clip's opening 274 and axle axle's end piece 284 are adapted to cooperate to maintain the clip 270 adjacent the axle's second end 280 when at least a portion of the axle's end piece 284 is disposed within the clip's opening 274.

When the clip 270 is fully inserted on the axle's second end 280, the clip 270 and the first and second protrusions 292, 294 are adapted to cooperate to maintain the first and second wheels 251, 252 adjacent a lower end of the hand truck 200 and are adapted to maintain the first and second wheels 251, 254 in a substantially fixed lateral position. When the wheel assembly 240 is fully assembled, the first and second wheels 251, 254 are substantially parallel (e.g., parallel) to one another and substantially perpendicular (e.g., perpendicular) to the axle 245.

### Hand Truck Sales Description

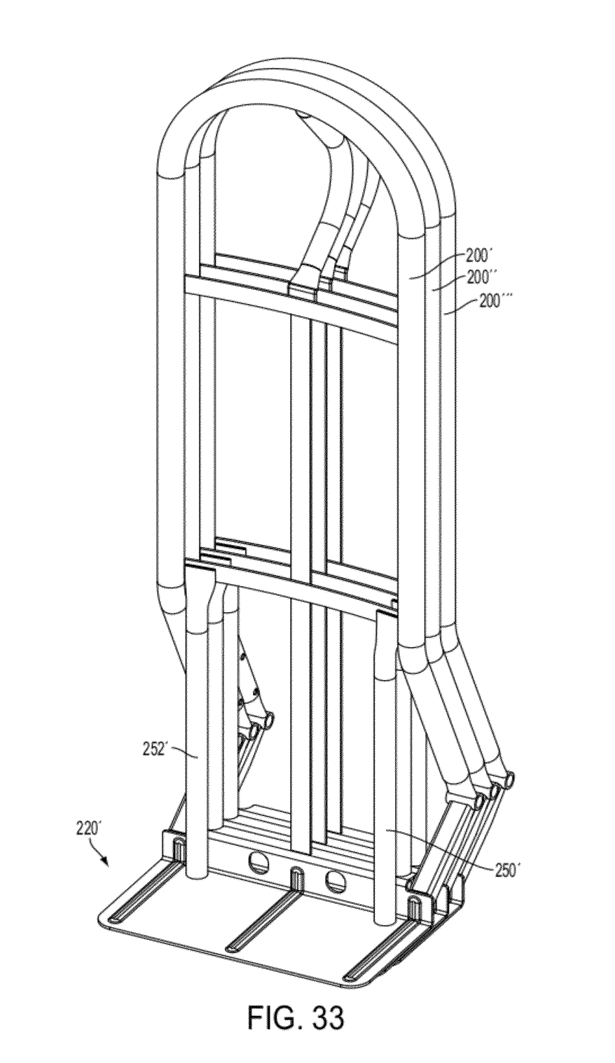

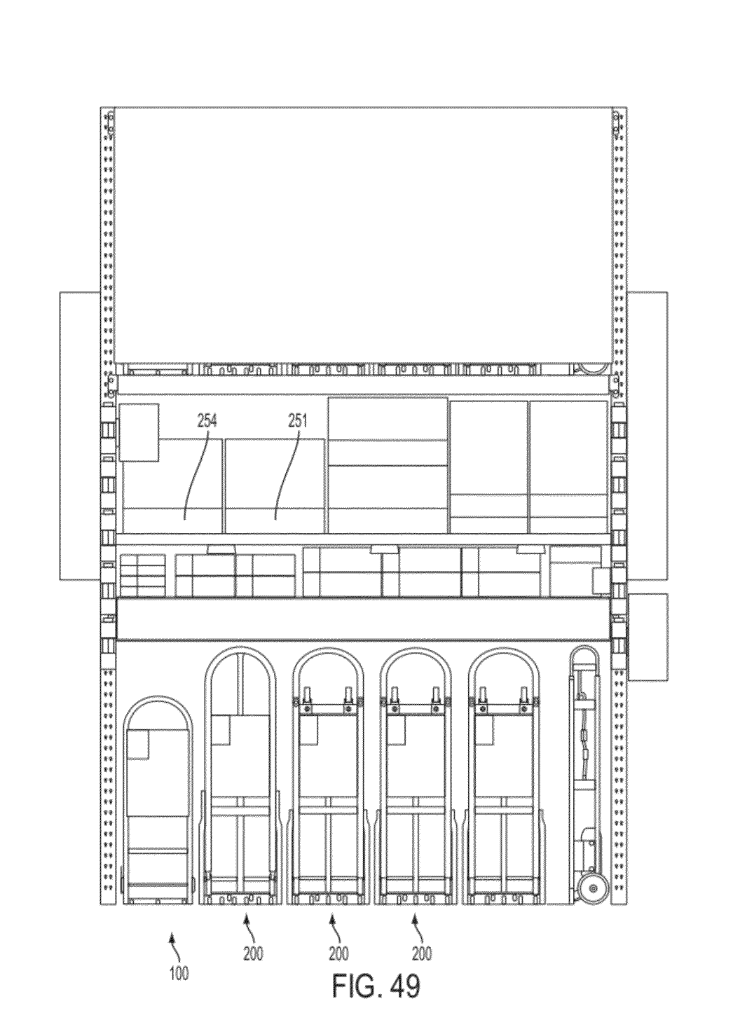

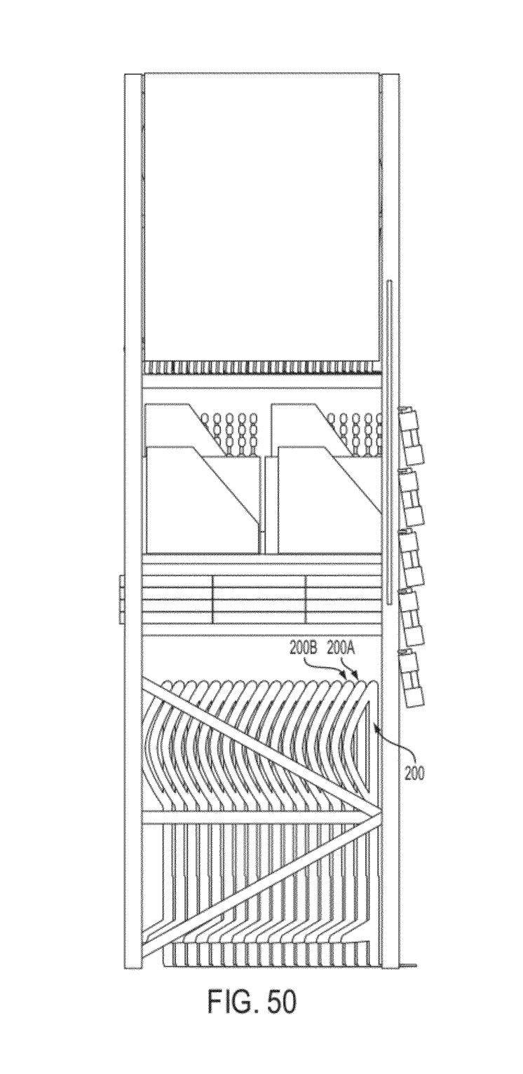

As shown in FIGS. 5, 11, 17, 23, 28, 31, and 33, when a plurality of hand truck bodies are positioned in a nesting relationship, the hand truck bodies fit in a compact space. This allows stores and other merchants selling hand trucks to display a plurality of hand trucks in a very limited amount of floor space. As shown in FIG. 49, merchants may display hand trucks 100, 200 in a hand truck bay. FIG. 50 shows a side view of an exemplary hand truck bay. As may be understood from FIG. 50, various embodiments of a hand truck bay may include a plurality of hand truck frames 200, 200A-B in a nested mating relationship. As shown in FIG. 49, a hand truck bay may display several embodiments of hand trucks 100, 200 from which a purchaser may choose. In the embodiment of a hand truck bay shown in FIG. 49, the hand truck bodies on display include the first exemplary hand truck body 100 and the second exemplary hand truck body 200. The hand truck bay shown in FIG. 49 further includes second and first wheel assemblies 251, 254 that correspond to the available hand truck frames in the hand truck bay. When selecting a hand truck for purchase, a purchaser may follow the steps of: (1) examining the available hand truck embodiments displayed in the hand truck bay; (2) selecting a hand truck body from the hand truck bay; (3) moving the selected hand truck out of the nested relationship with like hand trucks in the hand truck bay; and (4) retrieving a corresponding set of wheels and an axle from the hand truck bay. The purchaser may them assemble the purchased hand truck by attaching the axle and pair of wheels to the hand truck body as described above.

### CONCLUSION

Many modifications and other embodiments of the invention will come to mind to one skilled in the art to which this invention pertains having the benefits of the teachings presented in the foregoing descriptions and the associated drawings. For example, as will be understood by one skilled in the relevant field in life of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

We claim:

1. An assembly for attaching a first wheel and a second wheel adjacent an object suitable for rolling movement when the object is at least partially supported by the first and second wheels, the assembly comprising:
an axle defining:
a first end that is adapted for supporting the first wheel when the assembly is attached adjacent the object; and
a second end that is adapted for supporting the second wheel when the assembly is attached adjacent the object; and
a clip that is adapted to facilitate maintaining the second wheel in a substantially fixed lateral position adjacent the object in which the second wheel is rotatably connected adjacent the object, wherein:
the axle defines at least one axle recess adjacent the second end;
the clip comprises:
a first clip portion defining an elongated channel;
a second clip portion defining an opening in the second portion; and
a biasing mechanism that is adapted for biasing the first clip portion toward a first position in which the opening is aligned with at least a portion of the elongated channel;
the clip is adapted to allow a user to use the clip to facilitate maintaining the second wheel in the substantially fixed lateral position by executing one or more steps including:
positioning the second wheel adjacent the at least one axle recess; and
after positioning the second wheel adjacent the at least one axle recess, sliding the clip adjacent the second end so that:
a portion of the clip defining the elongated channel engages at least a portion of the axle defining the recess; and
at least a portion of the second end is disposed within the opening.

2. The assembly of claim 1, wherein the first clip portion is substantially planar.

3. The assembly of claim 2, wherein the second clip portion is substantially planar.

4. The assembly of claim 1, wherein:
the first clip portion and the second clip portion are portions a substantially continuous piece of material; and
the biasing mechanism comprises a rolled connection between the first clip portion and the second clip portion.

5. The assembly of claim 1, wherein the second clip portion comprises an outwardly turned portion that is adapted for facilitating the sliding of the second clip portion adjacent the second end, wherein:
the second end is adapted to exert a force on the outwardly turned portion as the user slides the clip onto the second end; and
the force causes the movement of the second clip portion away from the first clip portion as the user slides the clip onto the second end.

6. The assembly of claim 5, wherein at least a portion of the second end extends through the opening in the second clip portion when the outwardly turned portion slides at least fully past the second end.

7. The assembly of claim 1, wherein:
the at least one axle recess defines a plurality of recesses; and
at least a portion of the clip that defines the elongated channel engages at least a portion of the plurality of recesses when the user slides the clip adjacent the second end.

8. The assembly of claim 7, wherein the axle defines the recesses on opposing sides of the axle.

9. The assembly of claim 1, wherein the first end of the axle comprises at least one protrusion, wherein the at least one protrusion and the clip are adapted to cooperate to maintain the assembly in place when the assembly is supporting the first wheel and the second wheel adjacent the object.

10. The assembly of claim 9, wherein when the assembly is supporting the first wheel and the second wheel adjacent the object, at least a portion of the at least one protrusion engages at least a portion of the first wheel.

11. The assembly of claim 10, wherein:
the first end of the axle comprises a plurality of protrusions; and
when the assembly is supporting the first wheel and the second wheel adjacent the object, at least a portion of the plurality of protrusions engages at least a portion of the first wheel.

12. The assembly of claim 11, wherein the protrusions are disposed on opposing sides of the axle.

13. The assembly of claim 9, wherein the assembly is adapted to allow the user to install the assembly adjacent the object substantially without the use of tools.

14. The assembly of claim 1, wherein:
at least a portion of the clip that defines the opening engages at least a portion of the second end when the at least a portion of the second end is disposed within the opening; and
the second end is adapted to maintain the clip adjacent the second end when the at least a portion of the second end is disposed within the opening.

15. The assembly of claim 1, wherein the first wheel and the second wheel are substantially parallel and spaced apart when the assembly is supporting the first wheel and the second wheel adjacent the object.

16. The assembly of claim 1, wherein the first wheel and the second wheel are substantially perpendicular to the axle when the assembly is supporting the first wheel and the second wheel adjacent the object.

17. The assembly of claim 1, wherein the object is a hand truck.

18. A method of attaching a first wheel and a second wheel adjacent an object suitable for rolling movement using an axle assembly, when the object is at least partially supported by the first and second wheels, the axle assembly comprising:
(a) an axle defining a first end that is adapted for supporting the first wheel and a second end that defines at least one axle recess and is adapted for supporting the second wheel; and
(b) a clip comprising a first clip portion defining an elongated channel, a second clip portion defining an opening in the second portion, and a biasing mechanism that is adapted for biasing the first clip portion toward a first position in which the opening is aligned with at least a portion of the elongated channel, wherein:
the clip is adapted to facilitate maintaining the second wheel in a substantially fixed lateral position adjacent the object in which the second wheel is rotatably connected adjacent the object;
the method comprising the steps of:
positioning the first wheel adjacent the first end such that the first end supports the first wheel adjacent the object;
positioning the second wheel adjacent the at least one axle recess; and
sliding the clip adjacent the second end such that:
a portion of the clip defining the elongated channel engages at least a portion of the axle defining recess; and
at least a portion of the second end is disposed within the opening.

19. The method of claim 18, wherein:
the first end comprises at least one protrusion; and
the method further comprises the step of placing the first wheel adjacent the first end such that at least a portion of the at least one protrusion engages at least a portion of the first wheel.

20. An assembly for attaching a wheel and a second wheel adjacent an object suitable for rolling movement when the object is at least partially supported by the first and second wheels, the assembly comprising:
a first wheel locking means; and
a second wheel locking means, wherein:
the first wheel locking means is adapted for maintaining the first wheel in a substantially fixed lateral position adjacent the object when the assembly is attached adjacent the object; and
the second wheel locking means is adapted for maintaining the second wheel in a substantially fixed lateral position adjacent the object when the assembly is attached adjacent the object.
